(19) United States
(12) Patent Application Publication
(10) Pub. No.: US 2008/0118773 A1
(43) Pub. Date: May 22, 2008

(54) Complex Composition, Polymer Complex Compound And Polymer Light-Emitting Device

(76) Inventors: Satoshi Mikami, Ibaraki (JP); Masaaki Yokoyama, Osaka (JP); Yuichiro Kawamura, Kanagawa (JP)

Correspondence Address: SUGHRUE MION, PLLC, 2100 PENNSYLVANIA AVENUE, N.W., SUITE 800, WASHINGTON, DC, 20037, US

(21) Appl. No.: 10/550,059

(22) PCT Filed: Mar. 25, 2004
(86) PCT No.: PCT/JP04/04166

§ 371 Date: Jan. 30, 2008

(30) Foreign Application Priority Data
Mar. 26, 2003 (JP) 2003-084771

(51) Int. Cl. B32B 27/00; C08K 5/45; C08K 5/3432

(52) U.S. Cl. 428/690; 524/84; 524/102

(57) ABSTRACT

A complex composition characterized by comprising a polymer having repeating units represented by the formula (1) and a metal complex which luminesces in its triplet excited state; and a polymer complex compound characterized by comprising repeating units represented by the formula (1) and a metal complex structure which luminesces in its triplet excited state and by emitting visible light in a solid state. (1) (Ar₁ and Ar₂ each independently represents a trivalent aromatic hydrocarbon group or trivalent heterocyclic group; Ar₃ represents an aromatic hydrocarbon group or heterocyclic group, provided that the ring Ar₃ has bonded thereto one or more groups selected from the group consisting of alkyl, alkoxy, alkylthio, alkylsilyl, alkylamino, aryl, aryloxy, arylalkyl, arylalkoxy, arylalkenyl, arylalkynyl, arylamino, monovalent heterocyclic groups, and cyano; and X represents a single bond or connecting group.)

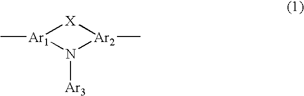

### TECHNICAL FIELD

The present invention relates to a complex composition, a polymer complex compound, and a polymer light-emitting device (hereafter may be referred to as polymer LED).

### BACKGROUND TECHNOLOGY

It has been known that a device using a metal complex showing light emission from triplet excited state (hereafter may be referred to as triplet light-emitting complex) as a light-emitting material for a light emitting layer of the light-emitting device, has high light emitting efficiency.

As the triplet light-emitting complex, for example, tri (2-phenylpyridine)iridium complex Ir(ppy)₃ (Appl.Phys.Lett., 75,4 (1999)), 2,3,7,8,12,13,17,18-octa ethyl 21H, 23H-Pt(II) porphin, PtOEP (Nature, 395,151 (1998)), etc.

And in order to improve the characteristic of the device, it is disclosed that a triplet light-emitting material is used for a light emitting layer, wherein said triplet light-emitting material is a composition in which poly(N-phenylcarbazole) shown by the below formula containing, as a repeating unit, a carbazolediyl group having a phenyl group on the nitrogen atom is added to the above triplet light-emitting complex (Ir(ppy)₃ or PtOEP). (JP 2003-7467 A).

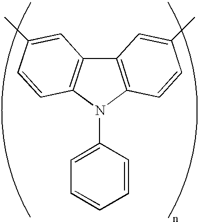

However, when film forming of the light emitting layer was carried out using the above triplet light-emitting material, there have been problems that the expected performance could not be attained stably about the luminance, light emitting efficiency, driving voltage, etc., of the light-emitting device.

### DISCLOSURE OF THE INVENTION

The object of the present invention is to provide a triplet light-emitting material having carbazolediyl group as a repeating unit, and when a light emitting layer of a light-emitting device is formed using said light-emitting material, the device can show the expected performance stably.

As a result of intensive studies to solve the above problems, the inventors found that when a light emitting layer of a light-emitting device is formed by using:

[1] a complex composition comprising a polymer compound and a triplet light-emitting complex, wherein the polymer compound contains a substituted carbazolediyl group as a repeating unit, which has a phenyl group or heterocyclic group on the nitrogen atom, and a substituent on their rings, or
[2] a polymer complex compound which contains the above substituted carbazolediyl group as a repeating unit, and a triplet light-emitting-complex structure, said light-emitting device can show the expected performances stably, and accomplished the present invention.

That is, the present invention relates to complex composition comprising a polymer compound which contains the repeating unit shown by the below formula (1), and a metal complex showing light-emission from triplet excited state.

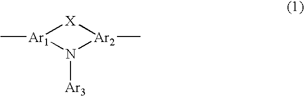

Wherein, Ar₁ and Ar₂ each independently represent a trivalent aromatic hydrocarbon group or a trivalent heterocyclic group. Ar₃ represents an aromatic hydrocarbon group or a heterocyclic group, and on the ring, the Ar₃ has a group selected from alkyl group, alkoxy group, alkylthio group, alkylsilyl group, alkylamino group, aryl group, aryloxy group, arylalkyl group, arylalkoxy group, arylalkenyl group, arylalkynyl group, arylamino group, monovalent heterocyclic group, and cyano group. X represents a single bond or a connecting group.

The present invention also relates to a polymer complex compound containing a repeating unit represented by formula (1), and a metal complex structure showing light-emission from triplet excited state, and shows visible light-emission in the solid state.

### BRIEF EXPLANATION OF DRAWING

FIG. 1 is a thin-film PL spectrum of Complex Composition 1 of the present invention.

FIG. 2 is a thin-film PL spectrum of Complex Composition 3 of the present invention.

FIG. 3 is a thin-film PL spectrum of Complex Composition 4 of the present invention.

FIG. 4 is a device structure of Example 3 of the present invention.

FIG. 5 shows a current density-external quantum-yield characteristic of Examples 3 and 4 of the present invention.

FIG. 6 shows a current density-external quantum-yield characteristic of Example 5 of the present invention.

FIG. 7 shows a current density-external quantum-yield characteristic of Example 6 of the present invention.

### BEST MODE FOR CARRYING OUT THE INVENTION

The complex composition of the present invention comprises a polymer compound containing the repeating unit shown by formula (1), and a metal complex showing light-emission from triplet excited state.

In formula (1), Ar₁ and Ar₂ each independently represent a trivalent aromatic hydrocarbon group or a trivalent heterocyclic group.

The trivalent aromatic hydrocarbon group means an atomic group in which three hydrogen atoms are removed from a benzene ring or a condensed ring, and examples of the trivalent aromatic hydrocarbon groups include following groups.

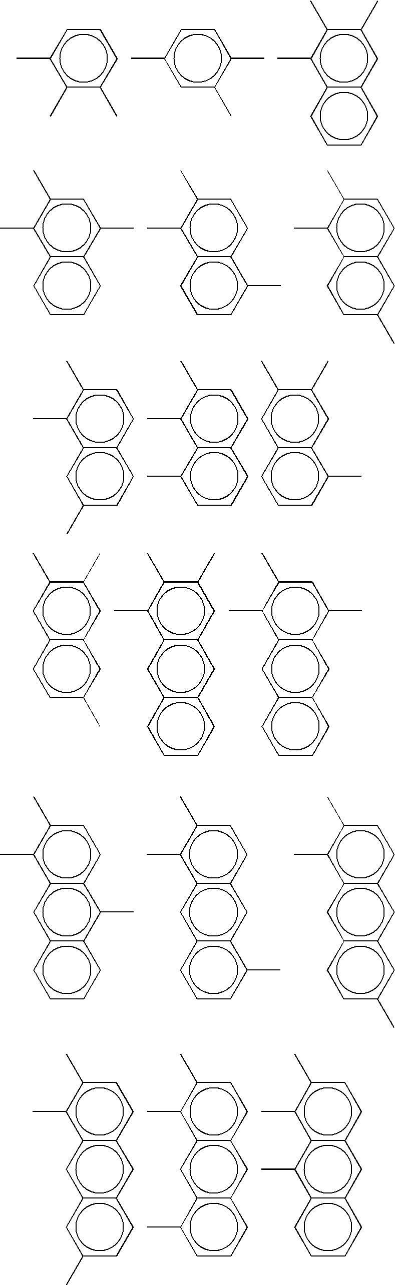

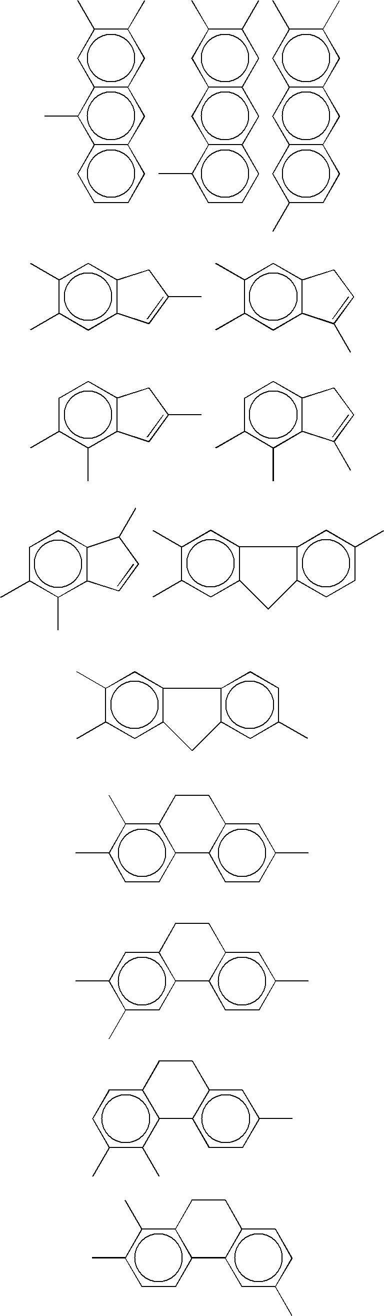

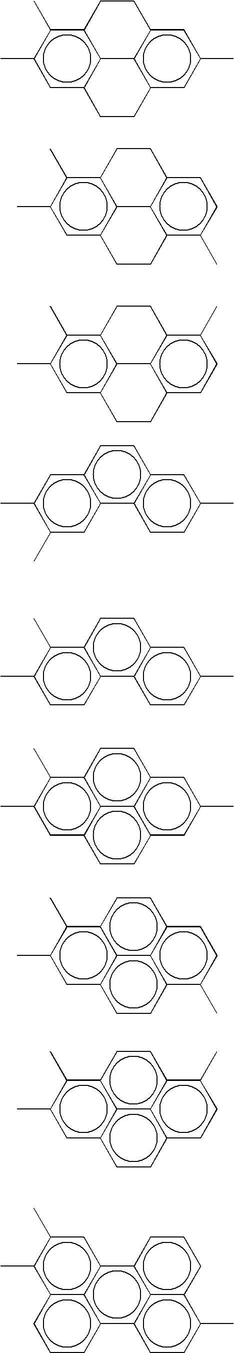

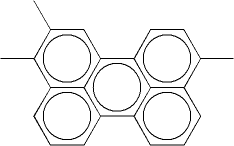

The above trivalent aromatic hydrocarbon group may have one or more substituents on the aromatic ring. As the substituent, exemplified are: halogen atom, alkyl group, alkoxy group, alkylthio group, alkylamino group, aryl group, aryloxy group, arylthio group, arylamino group, arylalkyl group, arylalkoxy group, arylalkylthio group, arylalkylamino group, acyl group, acyloxy group, amide group, imino group, substituted silyl group, substituted silyloxy group, substituted silylthio group, substituted silylamino group, monovalent heterocyclic group, arylalkenyl group, arylethynyl group, or cyano group.

The number of carbon atoms which constitute the ring of trivalent aromatic hydrocarbon group is usually 6-60, and preferably 6-20.

The trivalent heterocyclic group means an atomic group in which three hydrogen atoms are removed from a heterocyclic compound.

The heterocyclic compound means an organic compound having a cyclic structure in which at least one heteroatom such as oxygen, sulfur, nitrogen, phosphorus, boron, etc. is contained in the cyclic structure as the element other than carbon atoms.

Examples of the trivalent heterocyclic group include followings.

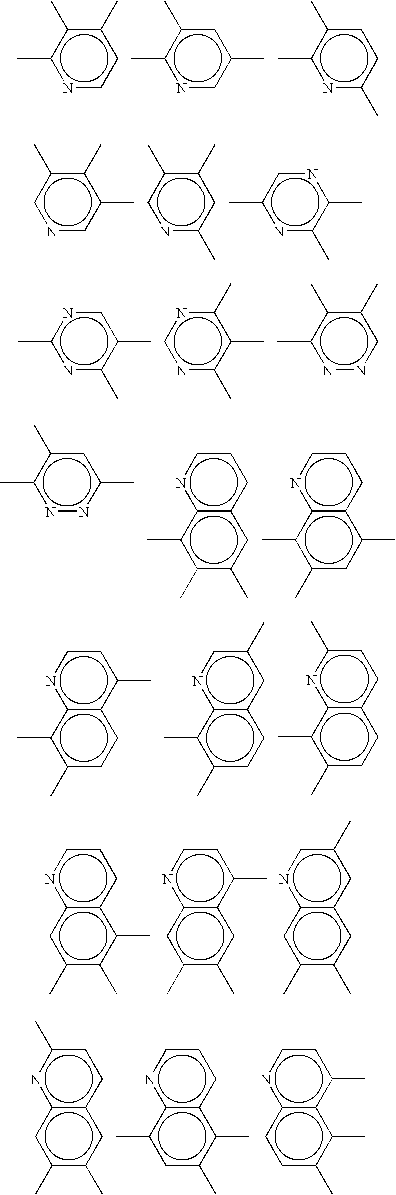

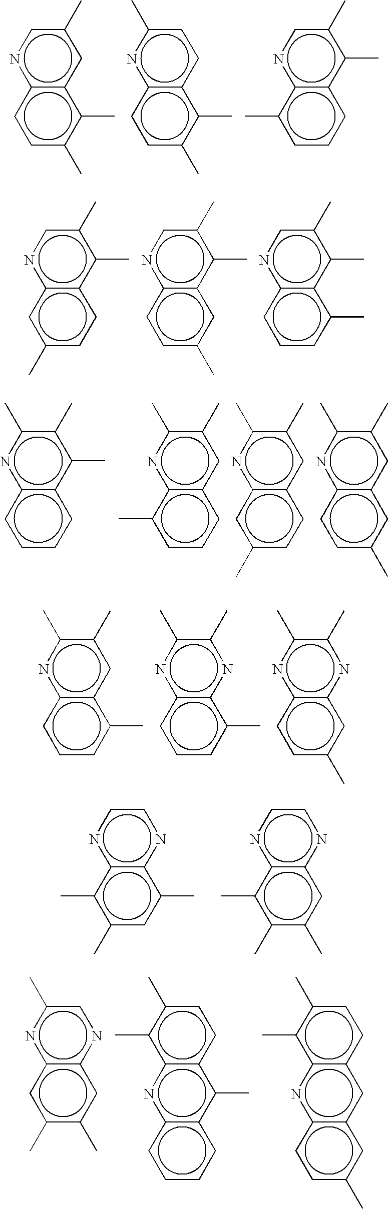

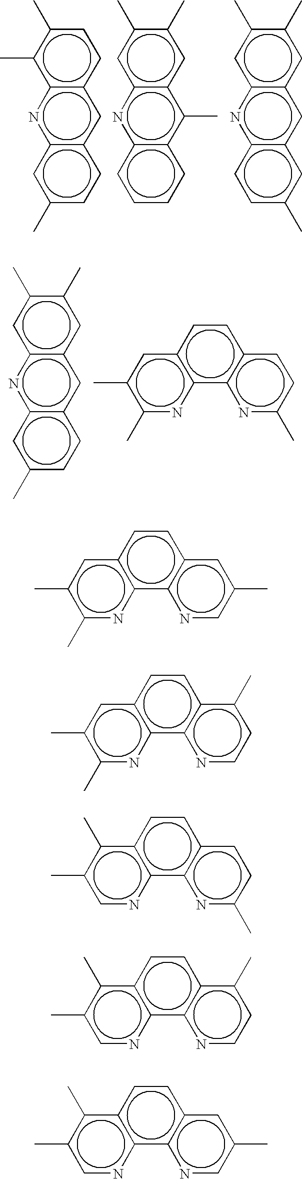

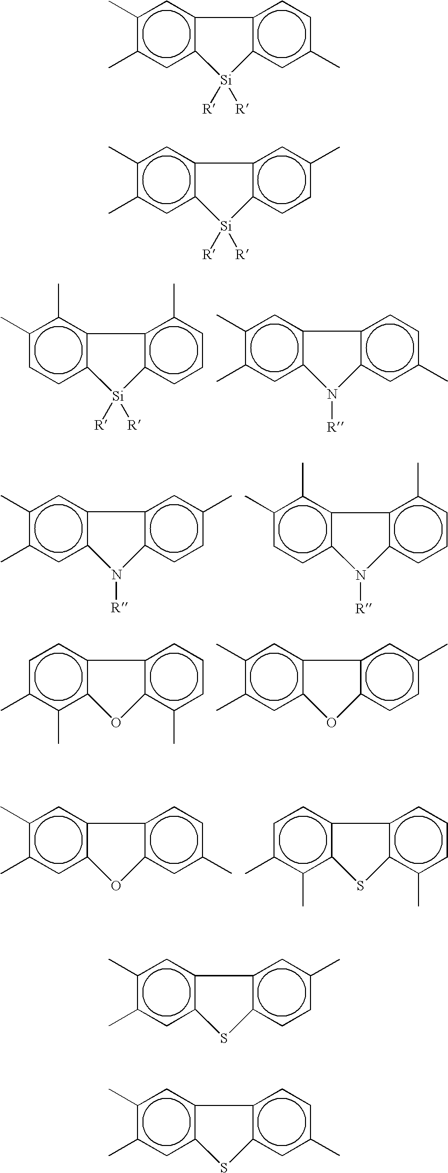

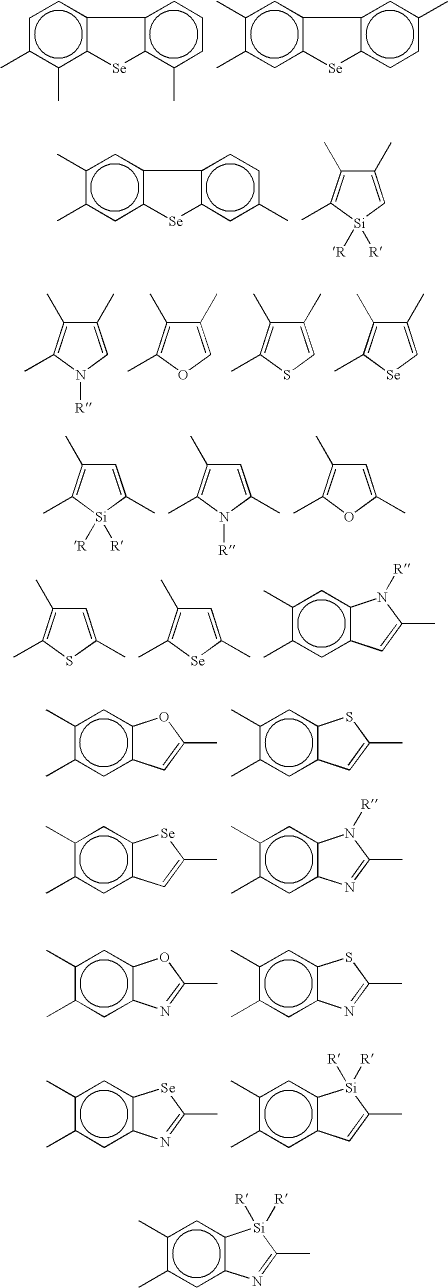

The above trivalent heterocyclic group may have one or more substituents on the ring. As the substituent, exemplified are: halogen atom, alkyl group, alkoxy group, alkylthio group, alkylamino group, aryl group, aryloxy group, arylthio group, arylamino group, aylalkyl group, arylalkoxy group, arylalkylthio group, arylalkylamino group, acyl group, acyloxy group, amide group, imino group, substituted silyl group, substituted silyloxy group, substituted silylthio group, substituted silylamino group, monovalent heterocyclic group, arylalkenyl group, arylethynyl group, or cyano group.

The number of carbon atoms which constitute the ring of trivalent aromatic heterocyclic group is usually 4-60, and preferably 4-20.

In the above formula, R′ each independently represents hydrogen atom, halogen atom (for example, chlorine, bromine, iodine), alkyl group, alkoxy group, alkylthio group, alkylamino group, aryl group, aryloxy group, arylthio group, arylamino group, arylalkyl group, arylalkoxy group, arylalkylthio group, arylalkylamino group, acyloxy group, amide group, arylalkenyl group, arylalkynyl group, monovalent heterocyclic group, or cyano group.

R″ each independently represents hydrogen atom, alkyl group, aryl group, arylalkyl group, substituted silyl group, acyl group, or monovalent heterocyclic group.

The alkyl group may be any of linear, branched or cyclic, and may have one or more substituents. The number of carbon atoms is usually about 1 to 20, and specific examples thereof include methyl group, ethyl group, propyl group, i-propyl group, butyl group, i-butyl group, t-butyl group, pentyl group, isoamyl group, hexyl group, cyclohexyl group, heptyl group, octyl group, 2-ethylhexyl group, nonyl group, decyl group, 3,7-dimethyloctyl group, lauryl group, etc.; and pentyl group, iso amyl group, hexyl group, octyl group, 2-ethyl hexyl group, decyl group, and 3,7-dimethyloctyl group are preferable.

The alkoxy group may be any of linear, branched or cyclic, and may have one or more substituents. The number of carbon atoms is usually about 1 to 20, and specific examples thereof include methoxy group, ethoxy group, propyloxy group, i-propyloxy group, butoxy group, i-butoxy group, t-butoxy group, pentyloxy group, isoamyloxy group, hexyloxy group, cyclohexyloxy group, heptyloxy group, octyloxy group, 2-ethyl hexyloxy group, nonyloxy group, decyloxy group, 3,7-dimethyl octyloxy group, lauryloxy group etc.; and pentyloxy group, isoamyloxy group, hexyloxy group, octyloxy group, 2-ethylhexyloxy group, decyloxy group, and 3,7-dimethyl octyloxy group are preferable.

The alkylthio group may be any of linear, branched or cyclic, and may have one or more substituents. The number of carbon atoms is usually about 1 to 20, and specific examples thereof include methylthio group, ethylthio group, propylthio group, i-propylthio group, butylthio group, i-butylthio group, t-butylthio group, pentylthio group, hexylthio group, cyclo hexylthio group, heptylthio group, octylthio group, 2-ethyl hexylthio group, nonylthio group, decylthio group, 3,7-dimethyloctylthio group, laurylthio group etc.; and pentylthio group, hexylthio group, octylthio group, 2-ethyl hexylthio group, decylthio group, and 3,7-dimethyloctylthio group are preferable.

The alkylsilyl group may be any of linear, branched or cyclic, and may have one or more substituents. The number of carbon atoms is usually about 1 to 60, and specific examples thereof include methylsilyl group, ethylsilyl group, propylsilyl group, i-propylsilyl group, butylsilyl group, i-butylsilyl group, t-butylsilyl group, pentylsilyl group, hexylsilyl group, cyclohexylsilyl group, heptylsilyl group, octylsilyl group, 2-ethylhexylsilyl group, nonylsilyl group, decylsilyl group, 3,7-dimethyloctylsilyl group, laurylsilyl group, trimethylsilyl group, ethyldimethylsilyl group, propyl dimethylsilyl group, i-propyldimethylsilyl group, butyl dimethylsilyl group, t-butyldimethyl silyl group, pentyl dimethylsilyl group, hexyldimethylsilyl group, heptyl dimethylsilyl group, octyldimethylsilyl group, 2-ethyl hexyl-dimethylsilyl group, nonyldimethylsilyl group, decyl dimethylsilyl group, 3,7-dimethyloctyl-dimethylsilyl group, lauryldimethyl silyl group etc.; and pentylsilyl group, hexyl silyl group, octylsilyl group, 2-ethylhexylsilyl group, decyl silyl group, 3,7-dimethyloctylsilyl group, pentyldimethyl silyl group, hexyldimethyl silyl group, octyldimethylsilyl group, 2-ethylhexyl-dimethylsilyl group, decyldimethylsilyl group, and 3,7-dimethyloctyl-dimethylsilyl group are preferable.

The alkylamino group may be any of linear, branched or cyclic, and may be monoalkylamino group or dialkylamino group. The number of carbon atoms is usually about 1 to 40, and specific examples thereof include methylamino group, dimethyl amino group, ethylamino group, diethylamino group, propyl amino group, i-propylamino group, butylamino group, i-butyl amino group, t-butylamino group, pentylamino group, hexyl amino group, cyclohexylamino group, heptylamino group, octyl amino group, 2-ethylhexylamino group, nonylamino group, decyl amino group, 3,7-dimethyloctyl amino group, laurylamino group, etc.; and pentylamino group, hexylamino group, octylamino group, 2-ethylhexylamino group, decylamino group, and 3,7-dimethyloctylamino group are preferable.

The aryl group has usually about 6 to 60 carbon atoms, and specific examples thereof include phenyl group, and C₁-C₁₂ alkoxyphenyl group (C₁-C₁₂ represents the number of carbon atoms 1-12. Hereafter the same), C₁-C₁₂ alkylphenyl group, 1-naphtyl group, 2-naphtyl group, etc.; and C₁-C₁₂ alkoxy phenyl group, and C₁-C₁₂ alkyl phenyl group are preferable.

The aryloxy group has usually about 6 to 60 carbon atoms, and specific examples thereof include phenoxy group, C₁-C₁₂ alkoxyphenoxy group, C₁-C₁₂ alkylphenoxy group, 1-naphtyloxy group, 2-naphtyloxy group, etc.; and C₁-C₁₂ alkoxyphenoxy group, and C₁-C₁₂ alkylphenoxy group are preferable.

The arylalkyl group has usually about 7 to 60 carbon atoms, and specific examples thereof include phenyl-C₁-C₁₂ alkyl group, C₁-C₁₂alkoxyphenyl-C₁-C₁₂alkyl group, C₁-C₁₂ alkylphenyl- alkyl group, 1-naphtyl-C₁-C₁₂alkyl group, 2-naphtyl- C₁-C₁₂ alkyl group, etc.; and C₁-C₁₂ alkoxyphenyl-C₁-C₁₂ alkyl group, and C₁-C₁₂ alkylphenyl-C₁-C₁₂ alkylgroup are preferable.

The arylalkoxy group has usually about 7 to 60 carbon atoms, and specific examples thereof include phenyl-C₁-C₁₂ alkoxy group, C₁-C₁₂ alkoxyphenyl-C₁-C₁₂ alkoxy group, C₁-C₁₂ alkyl phenyl-C₁-C₁₂ alkoxy group, 1-naphtyl-C₁-C₁₂ alkoxy group, 2-naphtyl-C₁-C₁₂ alkoxy group, etc.; and C₁-C₁₂ alkoxy phenyl-C₁-C₁₂ alkoxy group, and C₁-C₁₂ alkylphenyl-C₁-C₁₂ alkoxy group are preferable.

The arylalkenyl group has usually about 8 to 60 carbon atoms, and specific examples thereof include The number of carbon cis-phenylalkenyl group, trans-phenylalkenyl group, cis-tolylalkenyl group, trans-tolylalkenyl group, cis-1-naphtylalkenyl group, trans-1-naphtylalkenyl group, cis-2-naphtylalkenyl group, trans-2-naphtyl alkenyl group, etc.

The arylalkynyl group has usually about 8 to 60 carbon atoms, and specific examples thereof include phenylalkynyl group, tolylalkynyl group, 1-naphtylalkynyl group, 2-naphtylalkynyl group, etc.

The arylamino group has usually about 6 to 60 carbon atoms, and specific examples thereof include phenyl amino group, diphenylamino group, C₁-C₁₂ alkoxyphenylamino group, di(C₁-C₁₂ alkoxyphenyl)amino group, di(C₁-C₁₂ alkylphenyl)amino group, 1-naphtylamino group, 2-naphtylamino group, etc.; and C₁-C₁₂ alkylphenylamino group and di(C₁-C₁₂ alkylphenyl)amino group are preferable.

The monovalent heterocyclic group means an atomic group in which a hydrogen atom is removed from a heterocyclic compound. The number of carbon atoms is usually about 4 to 60, and specific examples thereof include thienyl group, C₁-C₁₂ alkyl thienyl group, pyroryl group, furyl group, pyridyl group, C₁-C₁₂ alkylpyridyl group, etc.; and thienyl group, C₁-C₁₂ alkyl thienyl group, pyridyl group, and C₁-C₁₂ alkyl pyridyl group are preferable.

In order to improve the solubility into a solvent, it is preferable that Ar₁ and Ar₂ have substituent, and one or more of them contain an alkyl chain having cyclic or long chain, and examples thereof include cyclopentyl group, cyclohexyl group, pentyl group, isoamyl group, hexyl group, octyl group, 2-ethylhexyl group, decyl group, 3,7-dimethyloctyl group.

Two substituents may be connected to form a ring. Furthermore, a part of carbon atoms in alkyl chain may be replaced by a group having a hetero atom, and examples of the hetero atom include an oxygen atom, a sulfur atom, a nitrogen atom, etc.

Furthermore, the aryl group and the heterocyclic group may have one or more substituents.

It is preferable that both Ar₁ and Ar₂ are trivalent aromatic hydrocarbon groups, and it is more preferable that both are monocyclic trivalent aromatic hydrocarbon groups.

Moreover, of monocyclic trivalent aromatic hydrocarbon groups, groups represented by the below formulas are preferable.

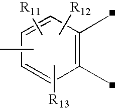

[in the formula, R₁₁, R₁₂, and R₁₃ each independently represent a hydrogen atom, halogen atom, alkyl group, alkoxy group, alkylthio group, alkylamino group, aryl group, aryloxy group, arylthio group, arylamino group, arylalkyl group, arylalkoxy group, arylalkylthio group, arylalkylamino group, acyl group, acyloxy group, amide group, imino group, substituted silyl group, substituted silyloxy group, substituted silylthio group, substituted silylamino group, monovalent heterocyclic group, arylalkenyl group, arylethynyl group, or cyano group. ▪ represents a bonding to N or X.]

Groups represented by the below formula are more preferable.

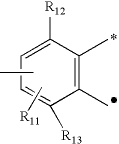

[in the formula, R₁₁, R₁₂, and R₁₃ each independently represent the same meaning as the above, * represent a bonding to X, and represents a bonding to N.]

Groups represented by the below formula are further preferable.

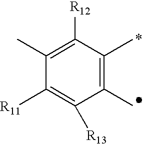

[in the formula, R₁₁, R₁₂, and R₁₃ each independently represent the same meaning as the above. * and represent the same meaning as the above.]

Here, the definition of the halogen atom in R₁₁, R₁₂ and R₁₃ and each groups and the specific examples are the same as those of the groups which may be contained on the above Ar₁.

In formula (1), Ar₃ represents an aromatic hydrocarbon group or a heterocyclic group, and said Ar₃ has on the ring a group selected from alkyl group, alkoxy group, alkylthio group, alkylsilyl group, alkylamino group, aryl group, aryloxy group, arylalkyl group, arylalkoxy group, arylalkenyl group, arylalkynyl group, arylamino group, monovalent heterocyclic group, and cyano group. In these groups, in order to improve the solubility in an organic solvent used for film forming, alkyl group and alkoxy group are preferable. Definitions of each of these groups contained on the ring of Ar₃, and the specific examples are the same as those of the groups which may be contained on the above Ar₁.

The aromatic hydrocarbon group has usually about 6 to 60 carbon atoms, preferably 6 to 20, and specific examples thereof include phenyl group, naphtyl group, etc. which have the above groups on their ring.

It is preferable that the aromatic hydrocarbon group is a group represented by the below formula.

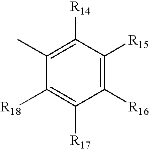

[in the formula, R₁₄, R₁₅, R₁₆, R₁₇, and R₁₈, each independently represent a hydrogen atom, alkyl group, alkoxy group, alkylthio group, alkylsilyl group, alkylamino group, aryl group, aryloxy group, arylalkyl group, arylalkoxy group, arylalkenyl group, arylalkynyl group, arylamino group, monovalent heterocyclic group, or cyano group, but at least one of R₁₄, R₁₅, R₁₆ and R₁₇ is not a hydrogen atom.]

Here, the definition of each group of R₁₄, R₁₅, R₁₆, R₁₇, and R₁₈ and the specific examples are the same as those of the groups which may be contained on the above Ar₁.

More specifically, those represented by the below formulas are exemplified.

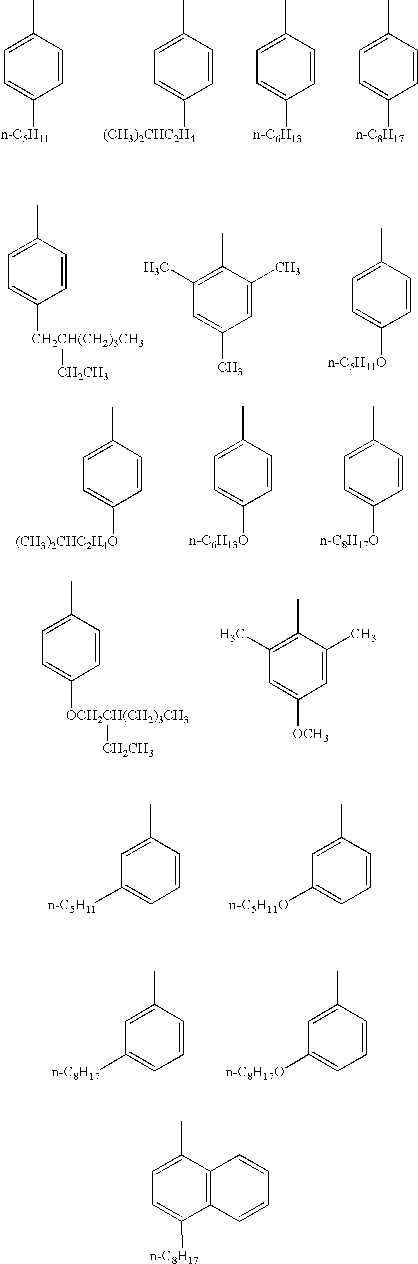

The heterocyclic group has usually about 4 to 60 carbon atoms, preferably 4 to 20, and specific examples thereof include thienyl group, pyroryl group, furyl group, and pyridyl group which contain the above groups on the ring.

More specifically, those represented by the below formulas are exemplified.

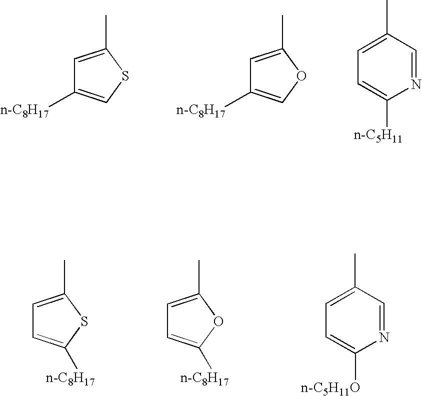

In the above formula (1), X represents a single bond or a connecting group.

Here, examples of the connecting groups include those of the below formulas.

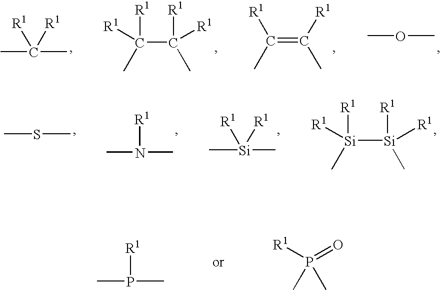

(in the formula, R₁ each independently represents a hydrogen atom, halogen atom, alkyl group, alkoxy group, alkylthio group, alkylamino group, aryl group, aryloxy group, arylthio group, arylamino group, arylalkyl group, arylalkoxy group, arylalkylthio group, arylalkylamino group, acyloxy group, amide group, arylalkenyl group, arylalkynyl group, monovalent heterocyclic group, or cyano group.)

Here, the definition of the halogen atom and each groups in R₁₁ and the specific examples are the same as those of the groups which may be contained on the above Ar₁.

As X, a single bond, —O— and —S— are preferable and a single bond is more preferable.

When a film for a light emitting layer of light-emitting device is formed using the polymer compound having the repeating unit of formula (1), said device can exhibit stably the expected performances, such as luminance, light emitting efficiency, and driving voltage.

When a coating method is used as a method of film forming, while the expected performances can be especially shown stably, and an excellent film-forming properties, for example, a light emitting layer which is uniform and has little surface roughness can be obtained easily, thus it is preferable.

As the polymer compound used for the complex composition of the present invention, it is preferable that the repeating unit shown by formula (5) is included in addition to the repeating unit shown by formula (1).

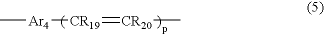

Ar₄ in the above formula (5) is an arylene group or a divalent heterocyclic group. Ar₄ may have substituents, such as alkyl group, alkoxy group, alkylthio group, alkylsilyl group, alkylamino group, aryl group, aryloxy group, arylalkyl group, arylalkoxy group, arylalkenyl group, arylalkynyl group, arylamino group, monovalent heterocyclic group, and cyano group. It is preferable that Ar₄ does not inhibit triplet luminescence.

The definition of the above substituents and the specific examples are the same as those of the groups which may be contained on the above Ar₁.

As Ar₄, an arylene group or a divalent heterocyclic group which is contained in all materials used as EL luminescence material from the former may be used, and it is preferable that the monomer does not inhibit triplet luminescence. Such materials are disclosed, for example, in WO99/12989 WO00/55927 WO01/49769A1 WO01/49768A2 and WO98/06773, U.S. Pat. No. 5,777,070, WO99/54385 WO00/46321, U.S. Pat. No. 6,169,163B1.

The arylene group includes those containing a benzene ring, a condensed ring, and two or more of independent benzene rings or condensed rings bonded through a group such as a direct bond, a vinylene group or the like. Examples thereof include phenylene group (for example, following formulas I-3), naphthalenediyl group (following formulas 4-13), anthracenylene group (following formulas 14-19), biphenylene group (following formulas 20-25), triphenylene group (following formulas 26-28), condensed ring compound group (following formulas 29-38), etc.

The number of the carbon atoms which constitute the ring is usually about 6 to 60, and preferably 6 to 20.

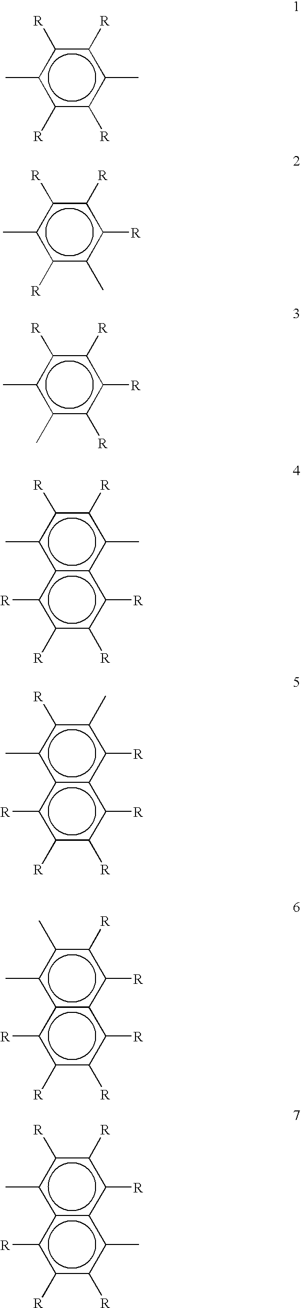

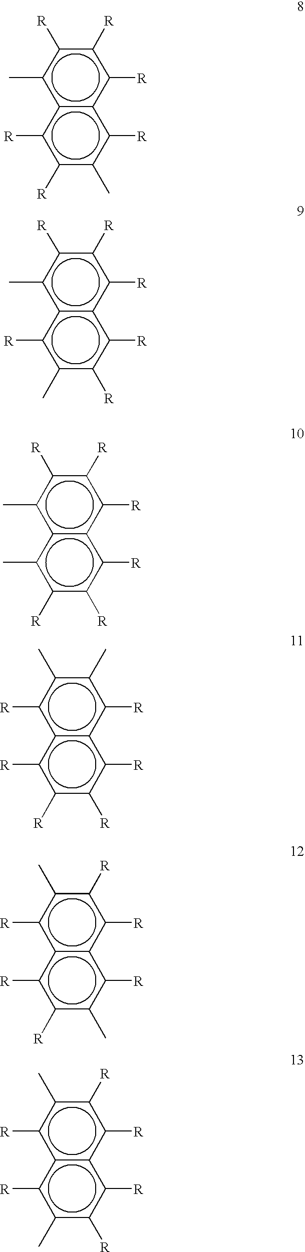

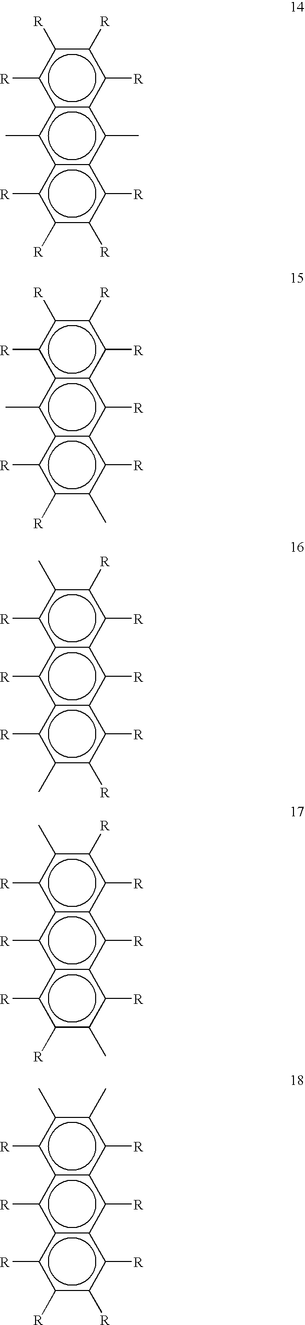

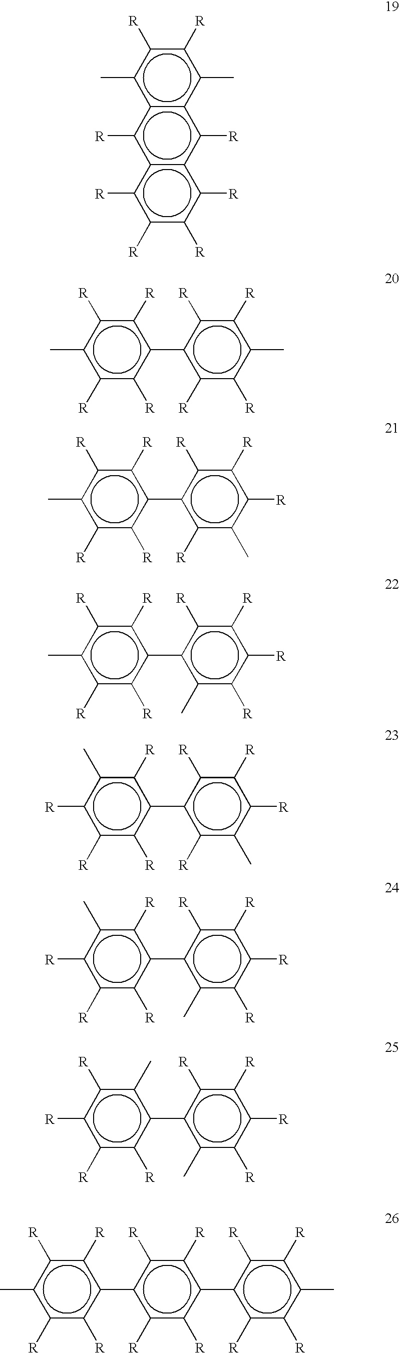

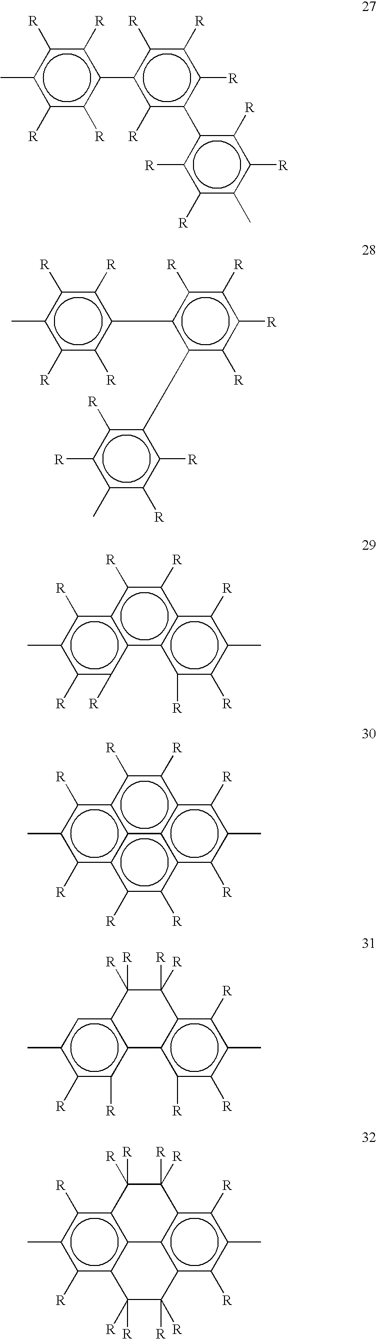

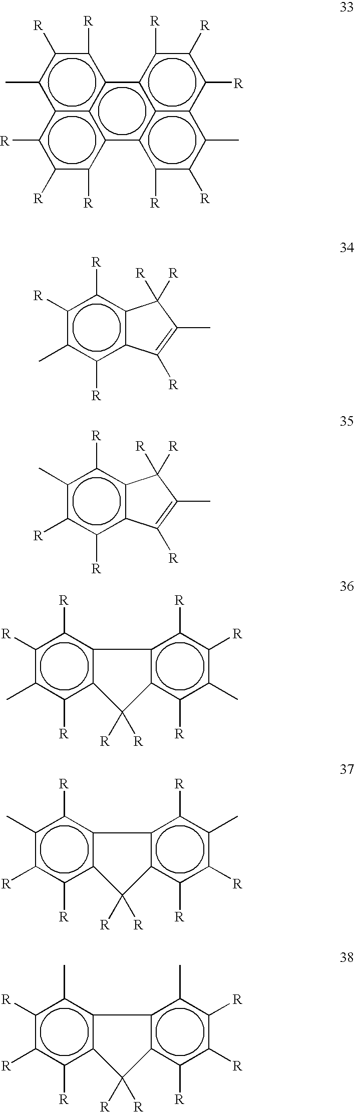

The divalent heterocyclic group means an atomic group in which two hydrogen atoms are removed from a heterocyclic compound, and the number of carbon atoms is usually about 4 to 60, preferably 4 to 20. Here, the number of carbon atoms of substituent is not counted as the number of carbon atoms of the divalent heterocyclic group.

The heterocyclic compound means an organic compound having a cyclic structure in which at least one heteroatom such as oxygen, sulfur, nitrogen, phosphorus, boron, etc. is contained in the cyclic structure as the element other than carbon atoms.

Examples of the divalent heterocyclic group include followings.

Divalent heterocyclic groups containing nitrogen as a hetero atom; pyridine-diyl group (following formulas 39-44), diaza phenylene group (following formulas 45-48), quinolinediyl group (following formulas 49-63), quinoxalinediyl group (following formulas 64-68), acridinediyl group (following formulas 69-72), bipyridyldiyl group (following formulas 73-75), phenanthrolinediyl group (following formulas 76-78), etc.

Groups having a fluorene structure containing silicon, nitrogen, sulfur, selenium, etc. as a hetero atom (following formulas 79-93). It is preferable to have an aromatic amine monomer containing a nitrogen atom, such as carbazole of formulas 82-84 or triphenylaminediyl group, in view of light emitting efficiency.

5 membered heterocyclic groups containing silicon, nitrogen, sulfur, selenium, etc. as a hetero atom: (following formulas 94-98).

Condensed 5 membered heterocyclic groups containing silicon, nitrogen, sulfur, selenium, etc. as a hetero atom: (following formulas 99-109), benzothiadiazole-4,7-diyl group, benzo oxadiazole-4,7-diyl group, etc.

5 membered heterocyclic groups containing silicon, nitrogen, sulfur, selenium, etc. as a hetero atom, which are connected at the a position of the hetero atom to form a dimer or an oligomer (following formulas 110-118); and

5 membered ring heterocyclic groups containing silicon, nitrogen, oxygen, sulfur, selenium, as a hetero atom is connected with a phenyl group at the a position of the hetero atom (following formulas 112-118).

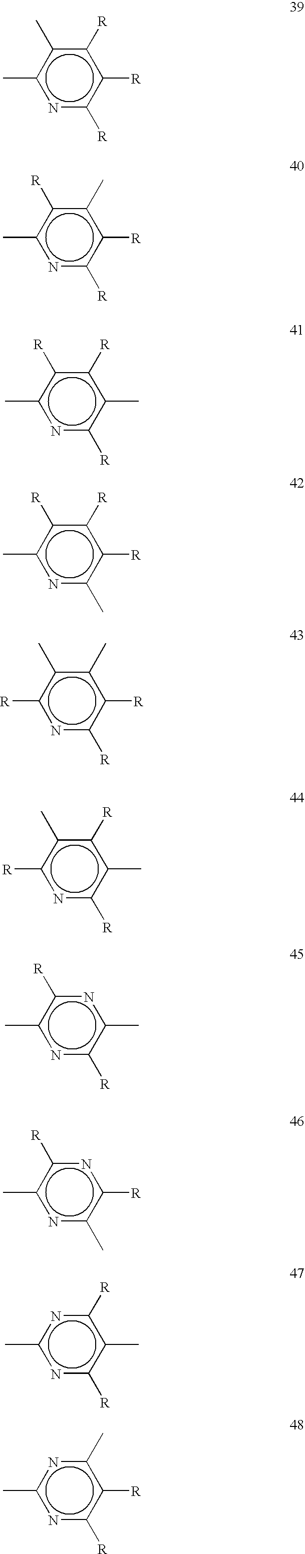

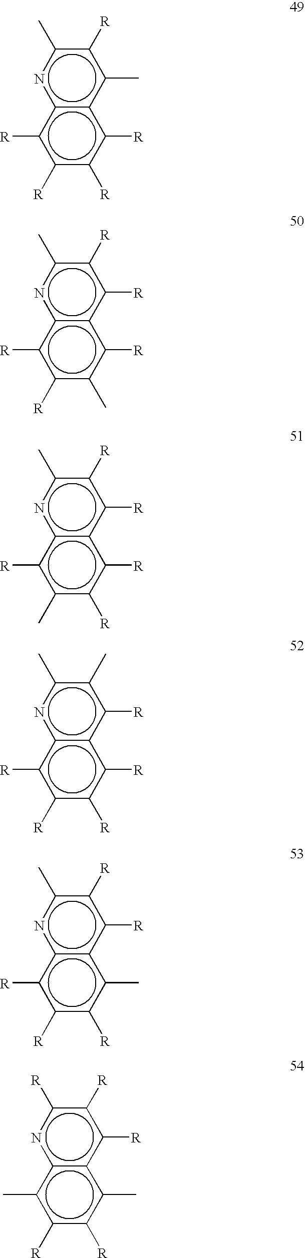

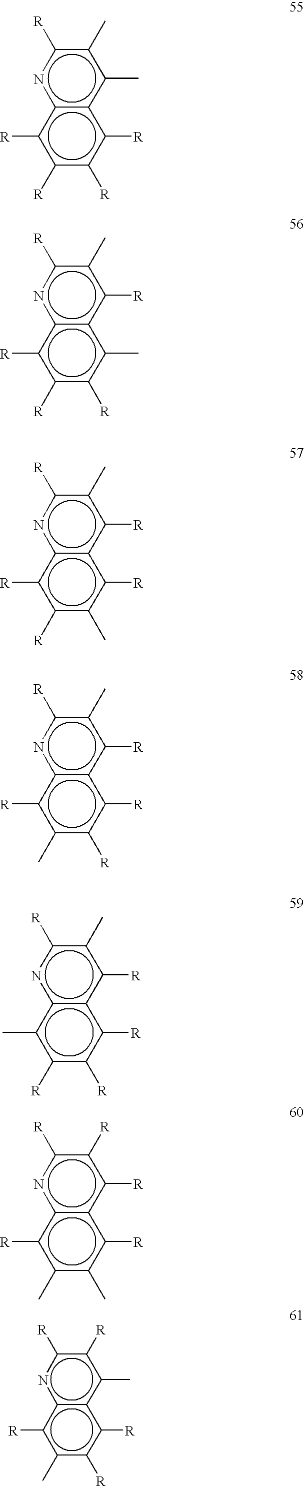

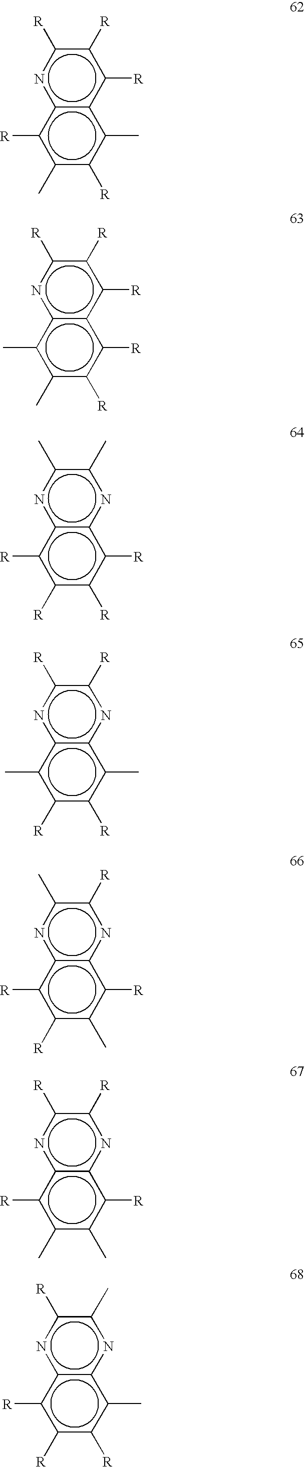

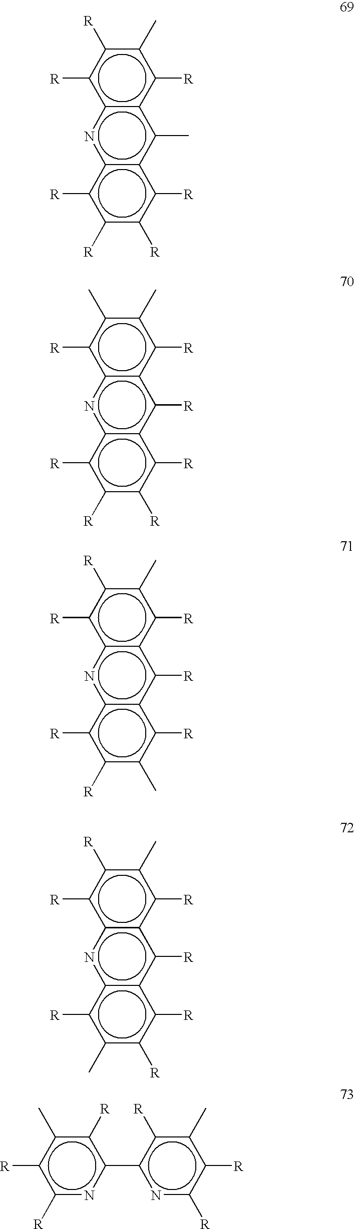

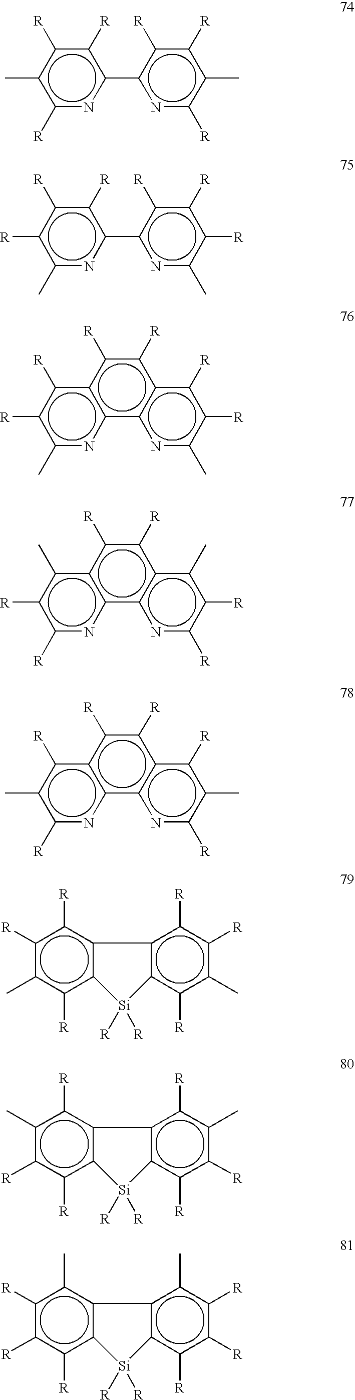

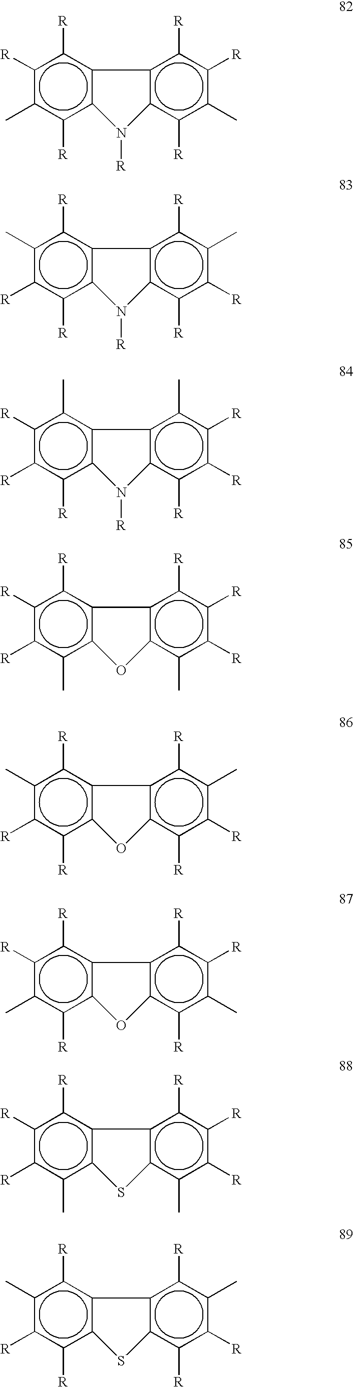

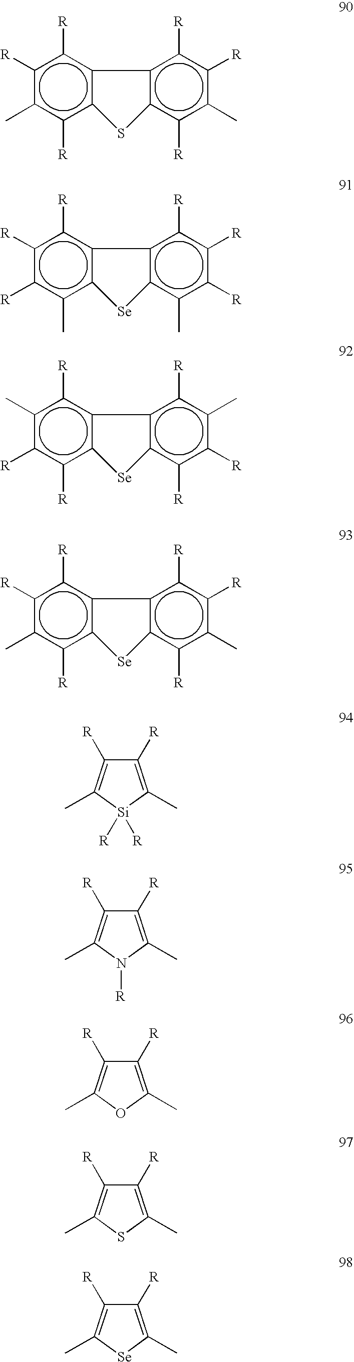

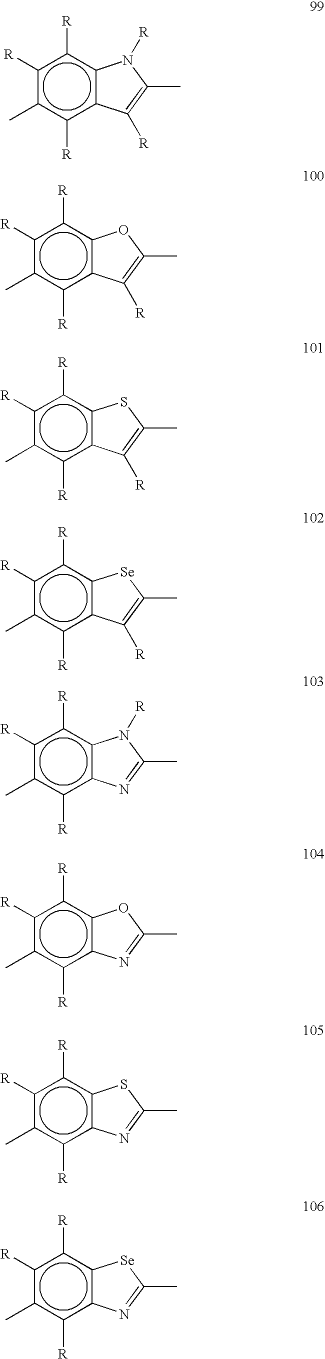

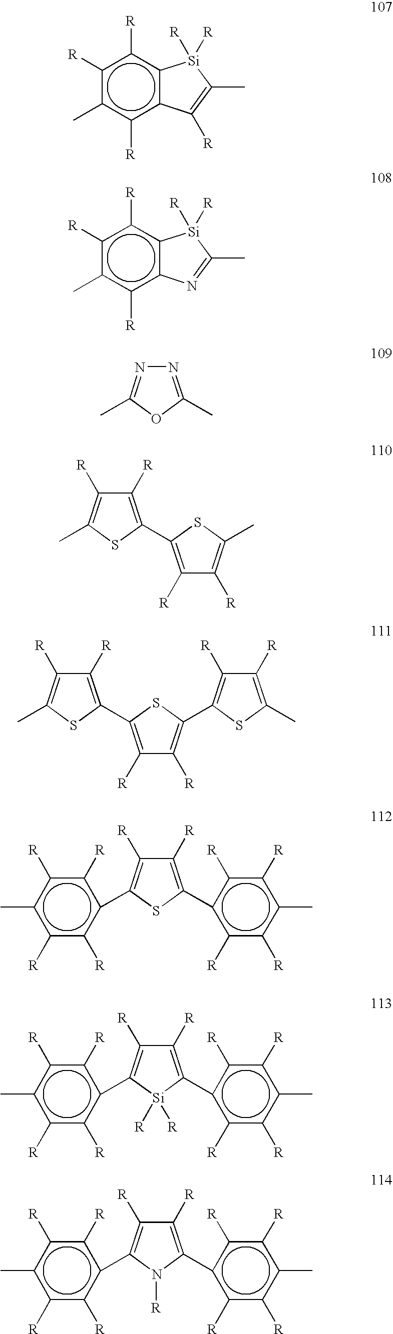

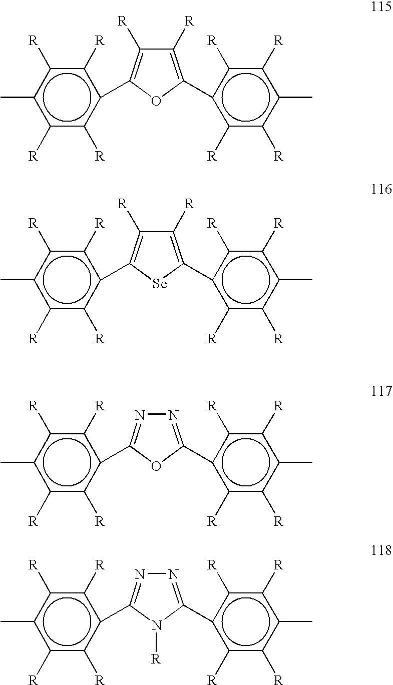

Here, R each independently represents a group from a hydrogen atom, alkyl group, alkoxy group, alkylthio group, alkylsilyl group, alkylamino group, aryl group, aryloxy group, arylalkyl group, arylalkoxy group, arylalkenyl group, arylalkynyl group, arylamino group, monovalent heterocyclic group, and cyano group. In order to improve the solubility in a solvent, alkyl group and alkoxy group are preferable, and it is preferable that there is little symmetry of the form of the repeating unit including the substituent.

Here, the definition of each group in the above R and the specific examples are the same as those of the groups which may be contained on the above Ar₁.

p in the above formula (5) is 0 or 1.

R₁₉ and R₂₀ in the above formula (5) each independently represents a hydrogen atom, alkyl group, aryl group, monovalent heterocyclic group, or cyano group.

When R₁₉ and R₂₀ represent a group other than a hydrogen atom and a cyano group, the alkyl group may be any of linear, branched or cyclic, and the number of carbon atoms is usually about 1 to 20. Specific examples thereof include methyl group, ethyl group, propyl group, butyl group, pentyl group, hexyl group, heptyl group, octyl group, nonyl group, decyl group, lauryl group, etc.; and methyl group, ethyl group, pentyl group, hexyl group, heptyl group, and octyl group are preferable.

The aryl group has usually about 6 to 60 carbon atoms, and specific examples thereof include phenyl group, C₁-C₁₂ alkoxy phenyl group (C₁-C₁₂ represents the number of carbon atoms 1-12. Hereafter the same), C₁-C₁₂ alkylphenyl group, 1-naphtyl group, 2-naphtyl group, etc.; and C₁-C₁₂ alkoxyphenyl group, and C₁-C₁₂ alkylphenyl group are preferable.

The monovalent heterocyclic group has usually about 4 to 60 carbon atoms, and specific examples thereof include thienyl group, C₁-C₁₂ alkylthienyl group, pyroryl group, furyl group, pyridyl group, C₁-C₁₂ alkylpyridyl group, etc.; and thienyl group, C₁-C₁₂ alkylthienyl group, pyridyl group, and C₁-C₁₂ alkylpyridyl group are preferable.

In the polymer compounds of the present invention, a conjugated polymer compound is preferable. Here, the conjugated polymer compound means a polymer compound in which delocalized π electron pair exist along with the main-chain of the polymer, i.e., a polymer compound whose main chain is a conjugated polymer. As the delocalized electrons, an unpaired electron or a lone electron pair may join to the resonance instead of a double bond.

Furthermore, the end group of polymer compound may also be protected with a stable group since if a polymerization active group remains intact, there is a possibility of reduction in light emitting property and life-time when made into an device. Those having a conjugated bond continuing to a conjugated structure of the main chain are preferable, and there are exemplified structures connected to an aryl group or heterocyclic compound group via a carbon-carbon bond. Specifically, substituents described as Chemical Formula 1 in JP-A-9-45478 are exemplified.

The polymer compound used for the present invention may also be a random, block or graft copolymer, or a polymer having an intermediate structure thereof, for example, a random copolymer having block property. From the viewpoint for obtaining a polymer compound having high fluorescent quantum yield, random copolymers having block property and block or graft copolymers are preferable than complete random copolymers. Further, a polymer having a branched main chain and more than three terminals, and a dendrimer may also be included.

The polymer compound used for the present invention, it is preferable that the polystyrene reduced number average molecular weights is 10³-10⁸.

Next, the metal complex showing light-emission from triplet excited state (triplet light-emitting complex) used for the complex composition of the present invention is explained. As the metal complex showing light-emission from triplet excited state, a complex showing phosphorescence emission or a complex showing fluorescence emission in addition to said phosphorescence emission is also included.

The triplet light-emitting complexes are those having been used as a low molecular weight EL material. Such materials are disclosed, for example, in: Nature, (1998) 395,151; Appl. Phys. Lett.,(1999) 75(1), 4; Proc. SPIE-Int. Soc. Opt. Eng.,(2001)4105; (Organic Light-Emitting Materials and Devices IV), 119; J. Am. Chem. Soc., (2001) 123, 4304; Appl. Phys. Lett.,(1997) 71(18), 2596; Syn. Met.,(1998) 94(1),103; Syn. Met.,(1999) 99(2), 1361; and Adv. Mater.,(1999),11 (10),852.

The central metal of the triplet light-emitting complex is usually an atom having atomic number of 50 or more, spin-orbit interaction occurs in the complex, and intersystem crossing between a singlet state and a triplet state can occur.

As the central metal, exemplified are rhenium, iridium, osmium, scandium, yttrium, platinum, gold; and lanthanoids such as europium, terbium, thulium, dysprosium, samarium, praseodymium, gadolinium, etc. Iridium, platinum, gold, and europium are preferable; iridium, platinum, and gold are especially preferable; and iridium is the most preferable.

The ligand of the triplet light-emitting complex is usually an organic ligand, and the number of carbon atoms is usually about 4 to 60.

As the ligand of the triplet light-emitting complex, exemplified are 8-quinolinol and derivatives thereof, benzoquinolinol and derivatives thereof, 2-phenyl-pyridine and derivatives thereof, 2-phenyl-benzothiazole and derivatives thereof, 2-phenyl-benzoxazole and derivatives thereof, porphyrin derivatives thereof, etc.

As the triplet light-emitting complex, followings are exemplified

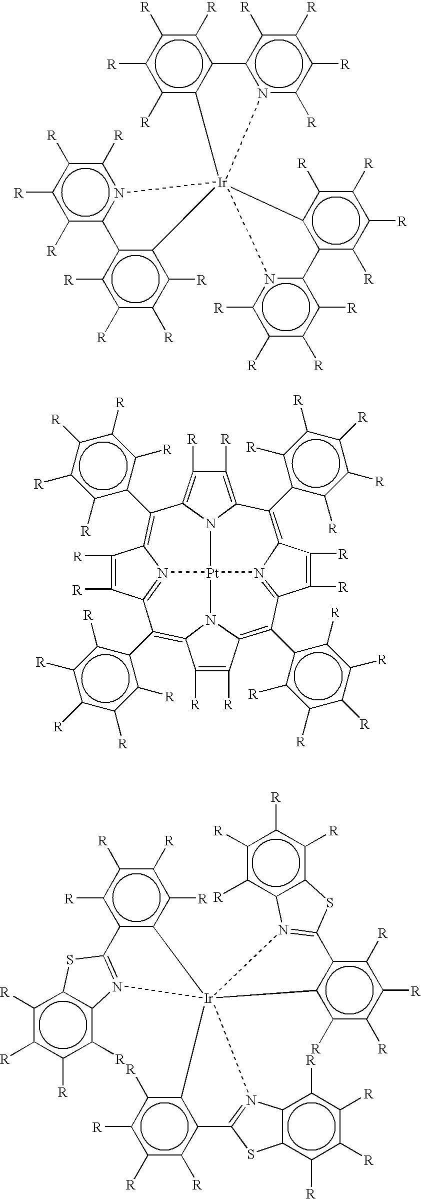

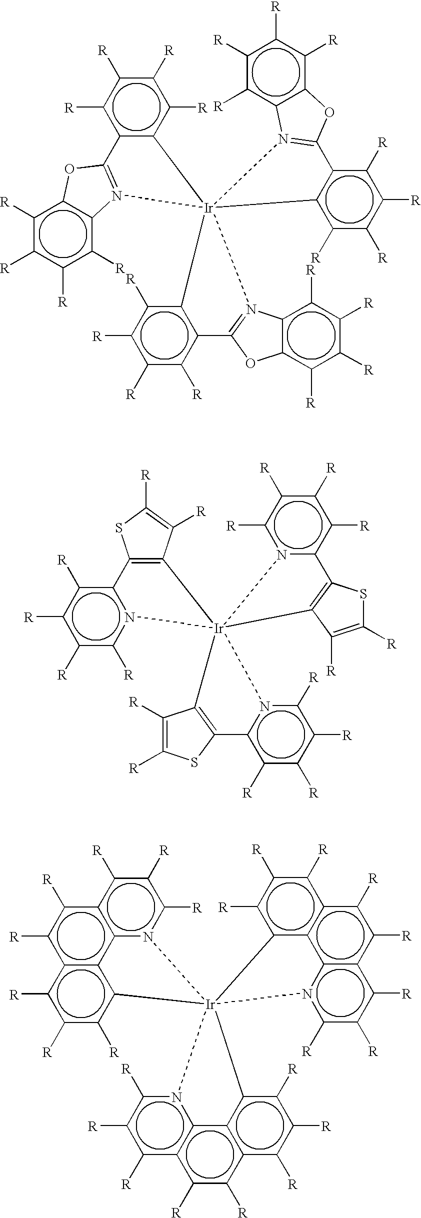

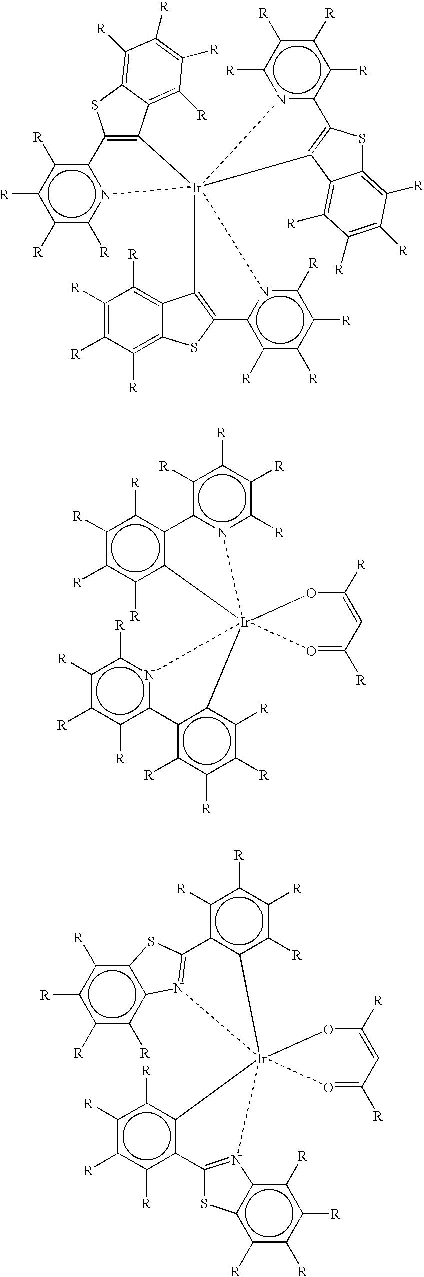

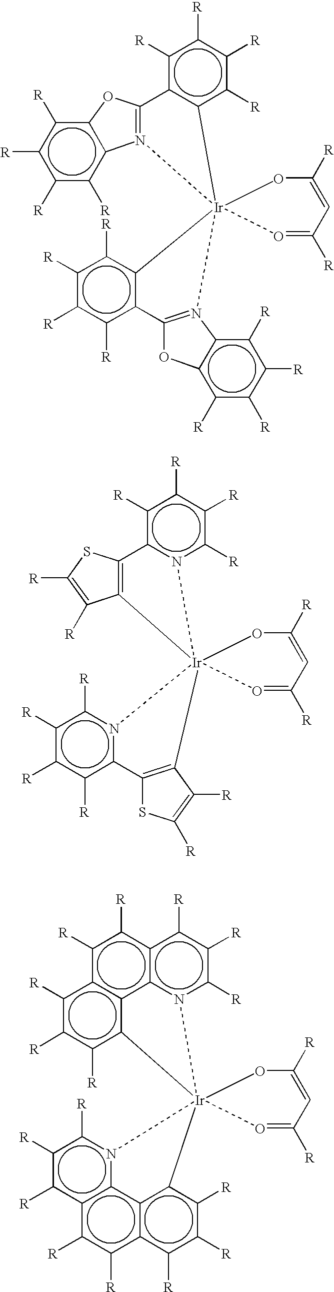

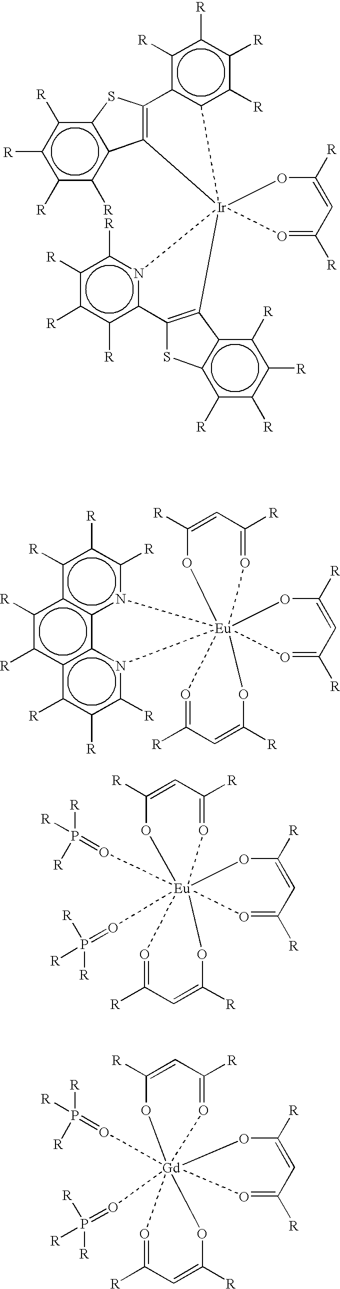

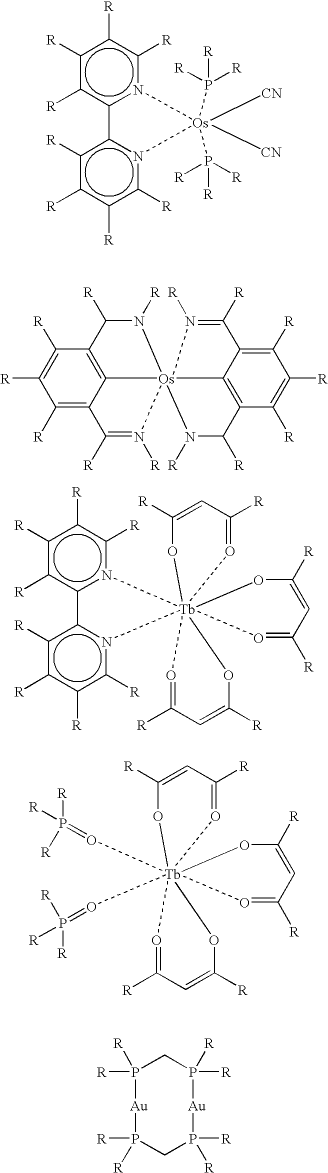

Here, R represents the same meaning as the above. Rs each independently represent a group selected from a hydrogen atom, alkyl group, alkoxy group, alkylthio group, alkylsilyl group, alkylamino group, aryl group, aryloxy group, arylalkyl group, arylalkoxy group, arylalkenyl group, arylalkynyl group, arylamino group, monovalent heterocyclic group, and cyano group. In order to improve the solubility in a solvent, alkyl group and alkoxy group are preferable, and it is preferable that there is little symmetry of the form of the repeating unit including the substituent.

The amount of the triplet light-emitting complex in the complex composition of the present invention is usually 0.01 to 20 parts by weight, preferably 0.1 to 20 parts by weight, wherein the amount of the polymer compound is 100 parts by weight.

As for the complex composition of the present invention, it is preferable that the amount of the electron transporting compound is usually 1 to 200 parts by weight, preferably 20 to 100 parts by weight, wherein the amount of the polymer compound is 100 parts by weight, from the viewpoint of charge balance.

As the electron transporting compounds, known compounds can be used, and there are exemplified oxadiazole derivatives, anthraquinonedimethane or derivatives thereof, benzoquinone or derivatives thereof, naphthoquinone or derivatives thereof, anthraquinone or derivatives thereof, tetracyanoanthraquinodimethane or derivatives thereof, fluorenone derivatives, diphenyldicyanoethylene or derivatives thereof, diphenoquinone derivatives, or metal complexes of 8-hydroxyquinoline or derivatives thereof, polyquinoline and derivatives thereof, polyquinoxaline and derivatives thereof, polyfluorene or derivatives thereof, and the like. Oxadiazole compounds and triazole compounds, etc. having following structures are exemplified, without being limited.

Specifically, there are exemplified those described in JP-A Nos. 63-70257, 63-175860, 2-135359, 2-135361, 2-209988, 3-37992, 3-152184, etc.

Among them, oxadiazole derivatives, benzoquinone or derivatives thereof, anthraquinone or derivatives thereof, or metal complexes of 8-hydroxyquinoline or derivatives thereof, polyquinoline and derivatives thereof, polyquinoxaline and derivatives thereof, polyfluorene or derivatives thereof are preferable, and 2-(4-biphenyl)-5-(4-t-butylphenyl)-1,3,4-oxadiazole, benzoquinone, anthraquinone, tris(8-quinolinol)aluminum and polyquinoline are further preferable.

Next, the polymer complex compound of the present invention is explained.

The polymer complex compound of the present invention comprises a metal complex structure showing light-emission from triplet excited state, and a repeating unit of the above formula (1).

The metal complex structure showing light-emission from triplet excited state may be included in the polymer main chain, may exist in the side chain, or may exist in the terminal.

As the metal complex structure showing light-emission from triplet excited state, for example, the structures shown by the below formula (3) are exemplified.

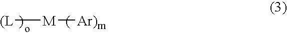

In the formula, M is a metal which is an atom having an atomic number of 50 or more, and intersystem crossing between a singlet state and a triplet state can occur in this complex by spin-orbit interaction.

Examples of M include: rhenium, iridium, osmium, scandium, yttrium, platinum, gold; and lanthanoids such as europium, terbium, thulium, dysprosium, samarium, praseodymium, gadolinium, etc. Iridium, platinum, gold, and europium are preferable, and iridium is especially preferable.

Ar is a ligand which bonds to M by one or more of nitrogen atom, oxygen atom, carbon atom, sulfur atom, or phosphorus atom; and has 1 or 2 or more connecting bonds which bond to the polymer chain of the polymer complex compound of the present invention in the arbitrary positions of Ar which do not bond to M.

The number of connecting bonds is usually 2 in the case where the metal complex structure is contained in a polymer main chain, and usually 1 in the case where the structure exists in a side chain or a terminal.

Ar include, for example, a ligand constituted by connection of heterocyclic rings, such as a pyridine ring, thiophene ring, and a benzoxazole ring, and benzene rings. Specific examples thereof include phenyl pyridine, 2-(paraphenylphenyl)pyridine, 7-bromobenzo[h]quinoline, 2-(4-thiophene-2-yl)pyridine, 2-(4-phenylthiophene-2-yl)pyridine, 2-phenyl benzoxazole, 2-(paraphenylphenyl)benzoxazole, 2-phenyl benzothiazole, 2-(paraphenylphenyl)benzothiazole, 2-(benzothiophene-2-yl)pyridine 7,8,12,13,17,18-hexakis ethyl-21H,23H-porphyrin etc., and these may have one or more substituents.

As the substituent of Ar, a halogen atom, alkyl group, alkenyl group, aralkyl group, arylthio group, arylalkenyl group, cyclic alkenyl group, alkoxy group, aryloxy group, alkoxy carbonyl group, aralkyloxy carbonyl group, aryloxy carbonyl group, aryl group, and monovalent heterocyclic group are exemplified, and the definition and the specific examples are the same as those of the above.

As for M, it is desirable to bond to at least one carbon atom of Ar.

In formula (3), it is preferable that Ar is a tetradentate ligand which bonds to M by any 4 atoms selected from a nitrogen atom, an oxygen atom, a carbon atom, a sulfur atom, and a phosphorus atom. For example, as a ligand in which 4 pyrrole rings are connected as cyclic, 7,8,12,13,17,18-hexakis ethyl-21H,23H-porphyrin is specifically exemplified.

In the above formula (3), it is preferable that Ar is a bidentate ligand in which Ar bonds to M to form 5 membered ring by two atoms selected from a nitrogen atom, an oxygen atom, a carbon atom, a sulfur atom, and a phosphorus atom. It is more preferable that M bonds to at least one carbon atom, and it is further preferable that Ar is a bidentate ligand shown by the below formula (4).

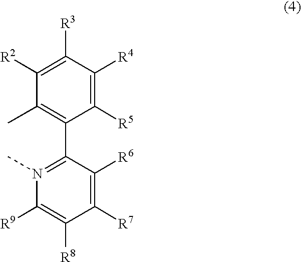

In the formula, R₂ to R₉ each independently represent a hydrogen atom, halogen atom, alkyl group, alkenyl group, aralkyl group, arylthio group, arylalkenyl group, cyclic alkenyl group, alkoxy group, aryloxy group, alkoxy carbonyl group, aralkyloxy carbonyl group, aryloxy carbonyl group, or aryl group. At least one of R₂-R₉ is a connecting bond with a polymer chain.

In the formula, L is a hydrogen atom, alkyl group, aryl group, heterocyclic ligand, carboxyl group, halogen atom, amide group, imide group, alkoxy group, alkylmercapto group, carbonyl ligand, alkene ligand, alkyne ligand, amine ligand, imine ligand, nitril ligand, isonitril ligand, phosphine ligand, phosphine oxide ligand, phosphite ligand, ether ligand, sulfone ligand, sulfoxide ligand, or sulfide ligand. m represents an integer of 1 to 5. o represents an integer of 0 to 5.

In L, as the alkyl groups, methyl group, ethyl group, propyl group, butyl group, cyclohexyl group, etc. are exemplified, and as the aryl groups, phenyl group, tolyl group, 1-naphtyl group, 2-naphtylgroup, etc. are exemplified. The heterocyclic ligand may be zero valent or monovalent, and examples of zero valent include, for example, 2,2′-bipyridyl, 1,10-phenanthroline, 2-(4-thiophene-2-yl)pyridine, 2-(benzo thiophene-2-yl)pyridine, etc., examples of monovalent include, for example, phenylpyridine, 2-(paraphenylphenyl)pyridine, 7-bromobenzo[h]quinoline, 2-(4-phenyl thiophene-2-yl)pyridine, 2-phenylbenzoxazole, 2-(paraphenyl phenyl)benzoxazole, 2-phenylbenzothiazole, 2-(paraphenyl phenyl)benzothiazole, etc.

As the carboxyl group, although not being limited, acetoxy group, naphthenate group, or 2-ethylhexanoate group is exemplified. As the halogen atom, although not being limited, a fluorine atom, chlorine atom, bromine atom, or iodine atom is exemplified. As the amide group, although not being limited, dimethyl amide group, diethyl amide group, diisopropyl amide group, dioctyl amide group, didecyl amide group, didodecyl amide group, bis(trimethylsilyl)amide group, diphenyl amide group, N-methyl anilide, or anilide group is exemplified. As the imide group, although not being limited, benzophenone imide etc. is exemplified. As the alkoxy group, although not being limited, methoxy group, ethoxy group, propoxy group, butoxy group, or phenoxy group is exemplified.

As the alkylmercapto group, although not being limited, methyl mercapto group, ethyl mercapto group, propyl mercapto group, butyl mercapto group, or phenyl mercapto group is exemplified. As the carbonyl ligand, although not being limited, exemplified are: ketones such as carbon monoxide, acetone, benzophenone; diketones such as acetyl acetone, and acenaphtho quinone; acetonate ligand such as acetylacetonate, dibenzomethylate, and thenoyl trifluoroacetonate, etc.

As the alkene ligand, although not being limited, ethylene, propylene, butene, hexene, or decene is exemplified. As the alkyne ligand, although not being limited, acetylene, phenyl acetylene, or diphenyl acetylene is exemplified. As the amine ligand, although not being limited, triethylamine or tributyl amine is exemplified. As the imine ligand, although not being limited, benzophenone imine or methylethylketone imine is exemplified. As the nitril ligand, although not being limited, acetonitrile or benzonitril is exemplified.

As the isonitril ligand, although not being limited, t-butyl isonitril or phenyl isonitril is exemplified. As the phosphine ligand, although not being limited, triphenyl phosphine, tritolyl phosphine, tricyclohexyl phosphine, or tributyl phosphine is exemplified. As the phosphine oxide ligand, although not being limited, tributyl phosphine oxide or triphenyl phosphine oxide is exemplified. As the phosphite ligand, although not being limited, triphenyl phosphite, tritolyl phosphite, tributyl phosphite, or triethyl phosphite is exemplified.

As the ether ligand, although not being limited, dimethyl ether, diethyl ether, or tetrahydrofuran is exemplified. As the sulfone ligand, although not being limited, dimethyl sulfone or dibutyl sulfone is exemplified. As the sulfoxide ligand, although not being limited, dimethyl sulfoxide or dibutyl sulfoxide is exemplified. As the sulfide ligand, although not being limited, ethyl sulfide or butyl sulfide is exemplified.

As the metal complex structure showing light-emission from triplet excited state, a residue in which a number of hydrogen atoms corresponding to the number of bonding to a polymer chain are removed from the ligand of triplet light-emitting complex, is exemplified. Specifically, a residue in which a number of Rs corresponding to the number of bonding to a polymer chain are removed from each of the concrete examples of triplet light-emitting complex shown by the above structural formula.

The metal complex structure showing light-emission from triplet excited state, may be included in the polymer main chain, may exist in the side chain, or may exist in the terminal.

As the case which the metal complex structure showing light-emission from triplet excited state is contained in the main chain, exemplified is a polymer compound which contains a structural unit having two connecting bonds in which two hydrogens are removed from the ligand of the triplet light-emitting complex (specifically, the structural unit which is a residue in which two Rs are removed from each the concrete examples of triplet light-emitting complex).

As such a structural unit, followings are exemplified.

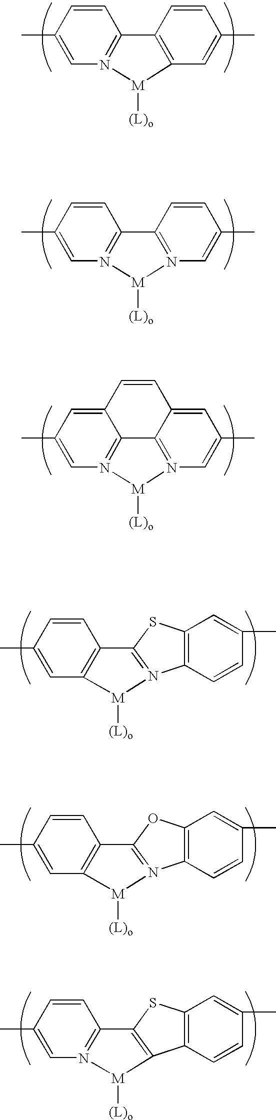

Moreover, when at least one of the ligands contained in the metal complex structure of the polymer compound of the present invention includes the same structure as the repeating unit contained in the polymer main chain, it is preferable since the metal content in the polymer compound is controllable. For example, in the process of complex-formation after producing a polymer compound, the metal content in the polymer compound is controllable by changing the amount of the metal, it is preferable. Specifically, following structures are exemplified.

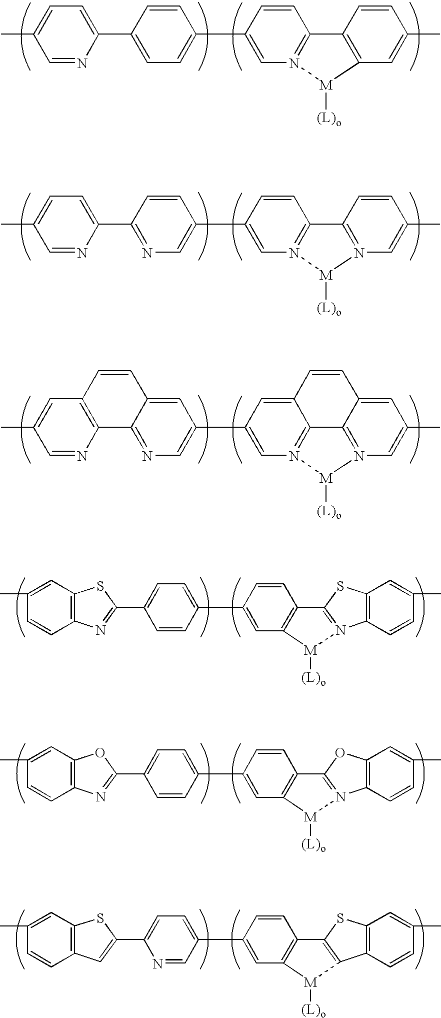

Examples of the case where a metal complex structure showing light-emission from triplet excited state exists in the side chain, include the case where a group having one connecting bond is connected to a polymer chain by: a direct bond, such as a single bond, and double bond; a bonding through atom, such as oxygen atom, sulfur atom, and selenium atom; or a bonding through divalent connecting groups, such as methylene group, alkylene group, and arylene group. The group having one connecting bond is a group in which one hydrogen is removed from the ligand of a triplet light-emitting complex, (concretely, a residual group in which one of R is removed from each of the examples of triplet light-emitting complex shown by the above structural formulas).

Among them, preferables are a single bond, double bond and arylene group, which contains a structure of conjugation continuing to the metal complex structure showing light-emission from triplet excited state of side chains.

As the structural unit having such a side chain (repeating unit), for example, the substituent of Ar₄, R₁₉ or R₂₀ in the repeating unit of the above formula (5), is a monovalent group having a metal complex structure showing light-emission from triplet excited state. Specifically, following structural units are exemplified.

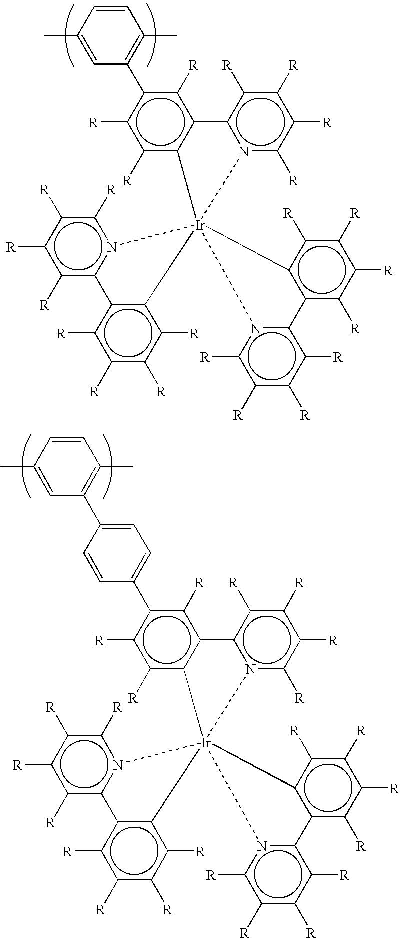

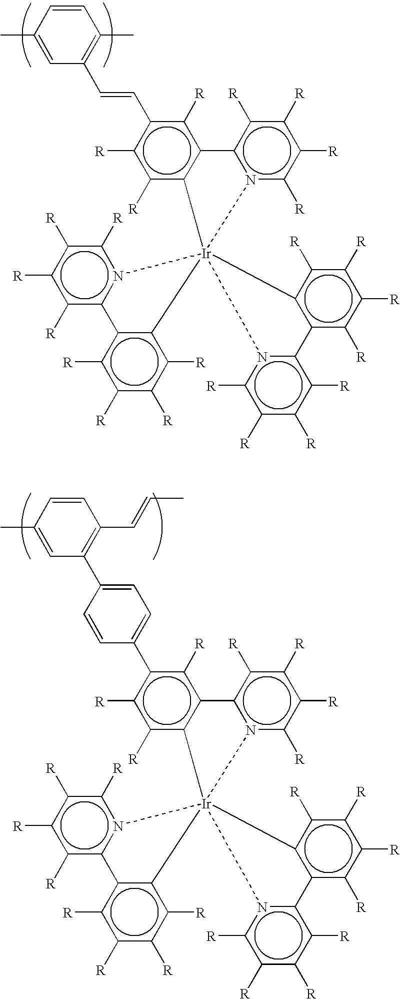

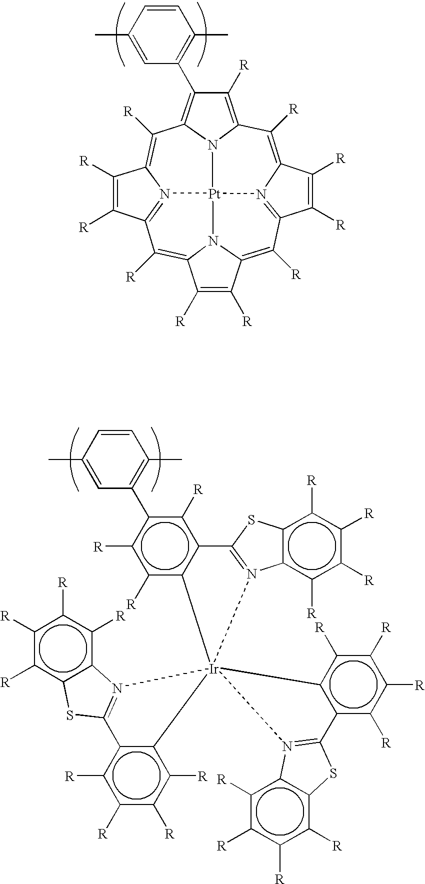

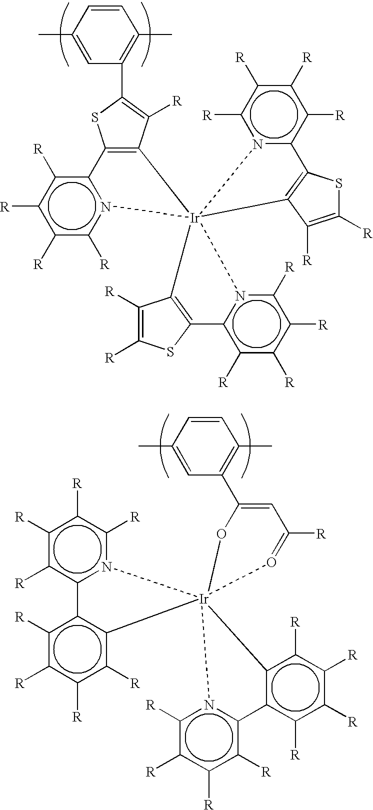

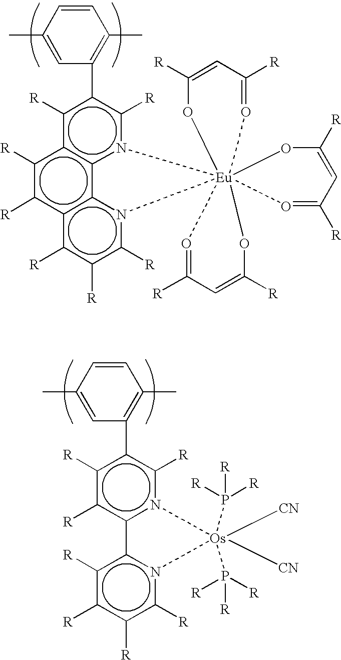

### In the formula, the definition of R is the same as the above.

Examples of the case where a metal complex structure showing light-emission from triplet excited state exists in the terminal of a polymer main chain, include a group having a connecting bond in which one hydrogen is removed from the ligand of a triplet light-emitting complex, (concretely, a residual group in which one of R is removed from each of the examples of triplet light-emitting complex shown by the above structural formulas). Specifically, following groups are exemplified.

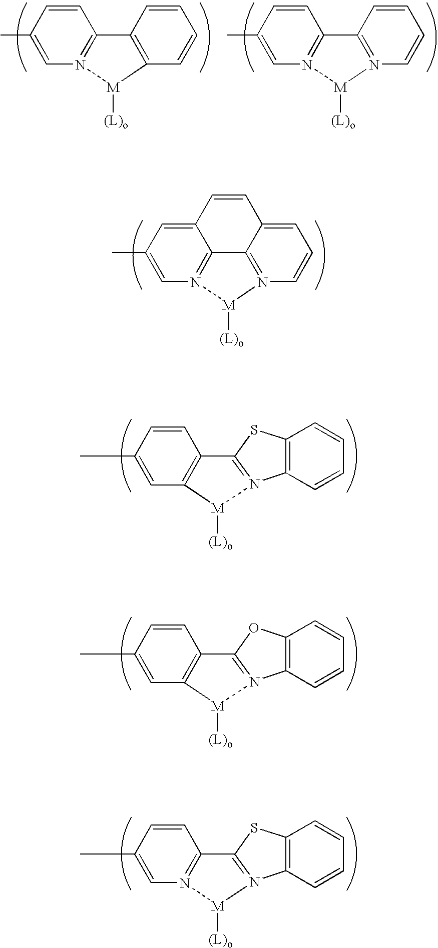

The polymer complex compound of the present invention may contain, for example, the repeating unit represented by the above (5) other than the repeating unit represented by formula (1), and a metal complex structure.

When the polymer complex compound of the present invention contains the repeating unit represented by the above (5), it is preferable that the repeating unit having the metal complex structure showing light-emission from triplet excited state is 0.01% by mole to 10% by mole based on the total of the repeating units represented by general formulas (1) and (5) and the structural unit (repeating unit) having the metal complex structure showing light-emission from triplet excited state.

Moreover, a conjugated polymer compound is preferable among the polymer complex compounds of the present invention.

The polymer complex compound of the present invention may have two or more kinds of metal complex structures showing light emission from triplet excited state. Namely, the polymer complex compound of the present invention, may have two or more kinds of metal complex structures showing light emission from triplet excited state, in any two or more of the main chain, side chain, or the terminal. The metal complex structures may have the same metal each other, and may have different metals. Moreover, metal complex structures may have mutually different light emission color. For example, exemplified is a case where both of a metal complex structure which emits green light and a metal complex structure which emits red light are contained in one polymeric light-emitting substance. In this case, a light emission color is controllable by designing to contain an appropriate amount of the metal complex structure, it is preferable.

Furthermore, the end group of polymer complex compound may also be protected with a stable group since if a polymerization active group remains intact, there is a possibility of reduction in light emitting property and life-time when made into an device. Those having a conjugated bond continuing to a conjugated structure of the main chain are preferable, and there are exemplified structures connected to an aryl group or heterocyclic compound group via a carbon-carbon bond. Specifically, substituents described as Chemical Formula 10 in JP-A-9-45478 are exemplified.

The polymer complex compound of the present invention may also be a random, block or graft copolymer, or a polymer having an intermediate structure thereof, for example, a random copolymer having block property. From the viewpoint for obtaining a polymer compound having high fluorescent quantum yield, random copolymers having block property and block or graft copolymers are preferable than complete random copolymers. Further, a polymer having a branched main chain and more than three terminals, and a dendrimer may also be included.

The polymer compound used for the present invention, it is preferable that the polystyrene reduced number average molecular weights is 10³-10⁸.

Next, the manufacture method of the polymer compound used for the polymer composition of the present invention and the polymer complex compound of the present invention will be explained.

As the synthetic method of the polymer compound of the present invention, exemplified are, for example, a method of polymerization by Suzuki coupling reaction from the corresponding monomer (Chem. Rev. volume 95, page 2457 (1995)); a method of polymerization by Grignard reaction; a method of polymerization by Yamamoto polymerizing method (Prog Polym. Sci. volume 17, pages 1153-1205 (1992); a method of polymerization by oxidizing agent, such as FeCl₃; a method of electrochemical oxidation polymerization; a method of decomposition of an intermediate polymer having an appropriate leaving group; etc. As the random polymerizing method (a method capable of giving a random copolymer), Yamamoto polymerization method, a method of polymerizing by Grignard reaction, a method of polymerizing by oxidizing agents, such as the and FeCl₃, a method of electrochemical oxidation polymerization, are exemplified. Among them, it is especially preferable to polymerize by the Yamamoto polymerization method.

In the Yamamoto polymerization method, usually a zero-valent nickel complex is used, and a halide is reacted in an ether solvent, such as tetrahydrofuran, and 1,4-dioxane, or an aromatic hydrocarbon solvent, such as toluene. As the zero-valent nickel complex, exemplified are bis(1,5-cyclo octadiene)nickel(0), (ethylene)bis(triphenylphosphine) nickel(0), tetrakis(triphenylphosphine)nickel, etc., and bis (1,5-cyclooctadiene)nickel(0) is preferable.

In this case, it is preferable to add a neutral ligand, in view of improvement in yield, high molecular weight polymerization.

The neutral ligand is a ligand which has neither an anion nor a cation, and exemplified are: nitrogen-containing ligands, such as 2,2′-bipyridyl, 1,10-phenanthroline, methylenebisoxazoline, and N,N′-tetramethylethylenediamine; and tertiary phosphine ligands, such as triphenyl phosphine, tritolyl phosphine, tributyl phosphine, and triphenoxy phosphine, etc. The nitrogen-containing ligand is preferable in view of versatility and cheapness, and 2,2′-bipyridyl is especially prferable in view of high reactivity and high yield. When using a neutral ligand, in view of reaction yield and cost, the using amount is preferably about 0.5 to 10 moles based on the zero-valent nickel complex, and more preferably 0.8 to 1.5 moles, and further preferably 0.9 to 1.1 moles.

Especially, in order to increase the molecular weight of polymer, a system in which 2,2′-bipyridyl is added as a neutral ligand to a system containing bis(1,5-cyclo octadiene)nickel(0) is preferable.

The amount of zero-valent nickel complex is not especially limited as long as the polymerization reaction is not inhibited. When the amount is too little, the molecular weight tends to become small, and when it is too large, the post-treatment tends to become complicated. Therefore, it is preferably 0.1 to 10 moles based on one mole of monomers, more preferably 1 to 5 moles, and further preferably 2 to 3.5 moles.

When the polymer complex compound of the present invention is used as a light emitting material of a polymer LED, the purity thereof exerts an influence on light emitting property, therefore, it is preferable that a monomer before polymerization is purified by a method such as distillation, sublimation purification, re-crystallization and the like before being polymerized and further, it is preferable to conduct a purification treatment such as re-precipitation purification, chromatographic separation and the like after the synthesis. In addition, the polymer compound of the present invention can be used as not only a light-emitting material but also an organic semiconductor material, an optical material, and a conductive material by doping.

The polymer complex compound of the present invention can be produced by reacting a monomer represented by X₁-A-X₂ (wherein, X₁ and X₂ each independently represent a halogen atom, alkyl sulfonyloxy group, or aryl sulfonyloxy group. -A- shows a repeating unit having a metal complex structure showing light-emission from triplet excited state) with X₃-D-X₄ (X₃ and X₄ each independently represent a halogen atom, alkyl sulfonyloxy group, or aryl sulfonyloxy group. D shows a repeating unit which does not contain a metal complex structure showing light-emission from triplet excited state) in existence of Ni catalyst.

In the above, when a polymer complex compound contains only the repeating unit represented by (1) substantially in addition to the metal complex structure, a monomer whose -D- is a unit represented by the above formula (1) is used.

When a repeating unit, for example, represented by (5) is contained in a polymer complex compound, a monomer whose -D- is a unit represented by the above formula (1), and a monomer whose -D- is a unit represented by the above formula (5) are used.

In the above, when -A- is specifically exemplified as a structural formula, a divalent group in which any two of Rs of the above triplet light-emitting complex are connecting bonds to adjacent repeating units, is exemplified.

Moreover, the polymer complex compound of the present invention can be produced by reacting a monomer represented by Y₁-A-Y₂ (Y₁ and Y₂ each independently represent a boric acid group or boric ester group) with a monomer represented by Z₁-D-Z₂ (Z₁ and Z₂ show a halogen atom, alkyl sulfonyloxy group, or aryl sulfonyloxy group. D is the same as that of the above) in existence of Pd catalyst.

Furthermore, the polymer complex compound of the present invention can be obtained by reacting Y₃-D-Y₄ (Y₃ and Y₄ are each independently boric acid group or boric ester group. D is the same as that of the above.) with a monomer represented by Z₃-A-Z₄ (Z₁ and Z₂ each independently represent a halogen atom, alkyl sulfonyloxy group, or aryl sulfonyloxy group) in existence of Pd catalyst.

In the above, it is preferable that the amount of the monomer represented by X₁-A-X₂, the monomer represented by Y₁-A-Y₂, or the monomer represented by Z₃-A-Z₄ is 0.01% by mole to 10% by mole based on the whole monomers.

Moreover, as the method of producing the polymer compound used for the complex composition of the present invention which do not have the metal complex structure showing light-emission from triplet state, for example, it can be obtained by reacting a monomer represented by X₃-D-X₄ in existence of Ni catalyst. and also can be obtained by reacting a monomer represented by Y₃-D-Y₄ with a monomer represented by X₃-D-X₄ in existence of Pd catalyst.

Examples of the halogen atoms represented by X₁, X₂, X₃, X₄, Z₁, Z₂, Z₃, and Z₄, include iodine, bromine, chlorine, etc.

Examples of the aryl sulfonyloxy groups include pentafluoro phenyl sulfonyloxy group, paratoluenesulfonyloxy group, etc., and examples of alkylsulfonyloxy groups include methane sulfonyloxy group trifluoromethane sulfonyloxy group etc.

Examples of the boric acid group and boric ester group, represented by Y₁, Y₂, Y₃, and Y₄, include a boric acid group, dimethyl boric ester, ethylene boric ester, trimethylene boric ester, etc.

As the example of a reaction in existence of Pd catalyst, the above Suzuki coupling reaction is exemplified.

As the palladium catalyst, palladium acetate, palladium [tetrakis(triphenylphosphine)] complex, bis(tricyclohexyl phosphine)palladium complex, etc. are exemplified.

Next, the polymer LED of the present invention will be explained. The polymer LED of the present invention comprises an light emitting layer between the electrodes consisting of an anode and a cathode, and the light emitting layer contains the complex composition or polymer complex compound of the present invention.

As the polymer LED of the present invention, exemplified are: a polymer LED having an electron transporting layer between a cathode and a light emitting layer; a polymer LED having an hole transporting layer between an anode and a light emitting layer; and a polymer LED having an electron transporting layer between an cathode and a light emitting layer, and a hole transporting layer between an anode and a light emitting layer.

Also exemplified are: a polymer LED having a layer containing a conductive polymer between at least one of the electrodes and a light emitting layer adjacently to the electrode; and a polymer LED having a buffer layer having a mean thickness of 2 nm or less between at least one of the electrodes and a light emitting layer adjacently to the electrode.

Specifically, the following structures a-d are exemplified.

a) anode/light emitting layer/cathode

b) anode/hole transporting layer/light emitting layer/cathode

c) anode/light emitting layer/electron transporting layer/cathode

d) anode/hole transporting layer/light emitting layer/electron transporting layer/cathode

(wherein, “/” indicates adjacent lamination of layers. Hereinafter, the same).

Herein, the light emitting layer is a layer having function to emit a light, the hole transporting layer is a layer having function to transport a hole, and the electron transporting layer is a layer having function to transport an electron. Herein, the electron transporting layer and the hole transporting layer are generically called a charge transporting layer.

The light emitting layer, hole transporting layer and electron transporting layer also may be used each independently in two or more layers.

Charge transporting layers disposed adjacent to an electrode, that having function to improve charge injecting efficiency from the electrode and having effect to decrease driving voltage of an device are particularly called sometimes a charge injecting layer (hole injecting layer, electron injecting layer) in general.

For enhancing adherence with an electrode and improving charge injection from an electrode, the above-described charge injecting layer or insulation layer having a thickness of 2 nm or less may also be provided adjacent to an electrode, and further, for enhancing adherence of the interface, preventing mixing and the like, a thin buffer layer may also be inserted into the interface of a charge transporting layer and light emitting layer.

The order and number of layers laminated and the thickness of each layer can be appropriately applied while considering light emitting efficiency and life of the device.

In the present invention, as the polymer LED having a charge injecting layer (electron injecting layer, hole injecting layer) provided, there are listed a polymer LED having a charge injecting layer provided adjacent to a cathode and a polymer LED having a charge injecting layer provided adjacent to an anode.

For example, the following structures e) to p) are specifically exemplified.

e) anode/charge injecting layer/light emitting layer/cathode

f) anode/light emitting layer/charge injecting layer/cathode

g) anode/charge injecting layer/light emitting layer/charge injecting layer/cathode

h) anode/charge injecting layer/hole transporting layer/light emitting layer/cathode

i) anode/hole transporting layer/light emitting layer/charge injecting layer/cathode

j) anode/charge injecting layer/hole transporting layer/light emitting layer/charge injecting layer/cathode

k) anode/charge injecting layer/light emitting layer/electron transporting layer/cathode

l) anode/light emitting layer/electron transporting layer/charge injecting layer/cathode

m) anode/charge injecting layer/light emitting layer/electron transporting layer/charge injecting layer/cathode

n) anode/charge injecting layer/hole transporting layer/light emitting layer/electron transporting layer/cathode

o) anode/hole transporting layer/light emitting layer/electron transporting layer/charge injecting layer/cathode

p) anode/charge injecting layer/hole transporting layer/light emitting layer/electron transporting layer/charge injecting layer/cathode

As the specific examples of the charge injecting layer, there are exemplified layers containing an conducting polymer, layers which are disposed between an anode and a hole transporting layer and contain a material having an ionization potential between the ionization potential of an anode material and the ionization potential of a hole transporting material contained in the hole transporting layer, layers which are disposed between a cathode and an electron transporting layer and contain a material having an electron affinity between the electron affinity of a cathode material and the electron affinity of an electron transporting material contained in the electron transporting layer, and the like.

When the above-described charge injecting layer is a layer containing an conducting polymer, the electric conductivity of the conducting polymer is preferably 10⁻⁵ S/cm or more and 10³ S/cm or less, and for decreasing the leak current between light emitting pixels, more preferably 10⁻⁵ S/cm or more and 10² S/cm or less, further preferably 10⁻⁵ S/cm or more and 10¹ S/cm or less.

Usually, to provide an electric conductivity of the conducting polymer of 10⁻⁵ S/cm or more and 10³ S/cm or less, a suitable amount of ions are doped into the conducting polymer.

Regarding the kind of an ion doped, an anion is used in a hole injecting layer and a cation is used in an electron injecting layer. As examples of the anion, a polystyrene sulfonate ion, alkylbenzene sulfonate ion, camphor sulfonate ion and the like are exemplified, and as examples of the cation, a lithium ion, sodium ion, potassium ion, tetrabutyl ammonium ion and the like are exemplified.

The thickness of the charge injecting layer is for example, from 1 nm to 100 nm, preferably from 2 nm to 50 nm.

Materials used in the charge injecting layer may properly be selected in view of relation with the materials of electrode and adjacent layers, and there are exemplified conducting polymers such as polyaniline and derivatives thereof, polythiophene and derivatives thereof, polypyrrole and derivatives thereof, poly(phenylene vinylene) and derivatives thereof, poly(thienylene vinylene) and derivatives thereof, polyquinoline and derivatives thereof, polyquinoxaline and derivatives thereof, polymers containing aromatic amine structures in the main chain or the side chain, and the like, and metal phthalocyanine (copper phthalocyanine and the like), carbon and the like.

The insulation layer having a thickness of 2 nm or less has function to make charge injection easy. As the material of the above-described insulation layer, metal fluoride, metal oxide, organic insulation materials and the like are listed.

As the polymer LED having an insulation layer having a thickness of 2 nm or less, there are listed polymer LEDs having an insulation layer having a thickness of 2 nm or less provided adjacent to a cathode, and polymer LEDs having an insulation layer having a thickness of 2 nm or less provided adjacent to an anode.

Specifically, there are listed the following structures q) to ab) for example.

q) anode/insulation layer having a thickness of 2 nm or less/light emitting layer/cathode

r) anode/light emitting layer/insulation layer having a thickness of 2 nm or less/cathode

s) anode/insulation layer having a thickness of 2 nm or less/light emitting layer/insulation layer having a thickness of 2 nm or less/cathode

t) anode/insulation layer having a thickness of 2 nm or less/hole transporting layer/light emitting layer/cathode

u) anode/hole transporting layer/light emitting layer/insulation layer having a thickness of 2 nm or less/cathode

v) anode/insulation layer having a thickness of 2 nm or less/hole transporting layer/light emitting layer/insulation layer having a thickness of 2 nm or less/cathode

w) anode/insulation layer having a thickness of 2 nm or less/light emitting layer/electron transporting layer/cathode

x) anode/light emitting layer/electron transporting layer/insulation layer having a thickness of 2 nm or less/cathode

y) anode/insulation layer having a thickness of 2 nm or less/light emitting layer/electron transporting layer/insulation layer having a thickness of 2 nm or less/cathode

z) anode/insulation layer having a thickness of 2 nm or less/hole transporting layer/light emitting layer/electron transporting layer/cathode

aa) anode/hole transporting layer/light emitting layer/electron transporting layer/insulation layer having a thickness of 2 nm or less/cathode

ab) anode/insulation layer having a thickness of 2 nm or less/hole transporting layer/light emitting layer/electron transporting layer/insulation layer having a thickness of 2 nm or less/cathode

A hole preventing layer is a layer having a function of transporting electrons and confining the holes transported from anode, and the layer is prepared at the interface on the side cathode of the light emitting layer, and consists of a material having larger ionization potential than that of the light emitting layer, for example, a metal complex of bathocuproine, 8-hydroxy quinoline, or derivatives thereof.

The film thickness of the hole preventing layer, for example, is 1 nm to 100 nm, and preferably 2 nm to 50 nm.

Specifically, there are listed the following structures ac) to an) for example.

ac) anode/charge injection layer/light emitting layer/hole preventing layer/cathode
ad) anode/light emitting layer/hole preventing layer/charge injection layer/cathode
ae) anode/charge injection layer/light emitting layer/hole preventing layer/charge injection layer/cathode
af) anode/charge injection layer/hole transporting layer/light emitting layer/hole preventing layer/cathode
ag) anode/hole transporting layer/light emitting layer/hole preventing layer/charge injection layer/cathode
ah) anode/charge injection layer/hole transporting layer/light emitting layer/hole preventing layer/charge injection layer/cathode
ai) anode/charge injection-layer/light emitting layer/hole preventing layer/charge transporting layer/cathode
aj) anode/light emitting layer/hole preventing layer/electron transporting layer/charge injection layer/cathode
ak) anode/charge injection layer/light emitting layer/hole preventing layer/electron transporting layer/charge injection layer/cathode
al) anode/charge injection layer/hole transporting layer/light emitting layer/hole preventing layer/charge transporting layer/cathode
am) anode/hole transporting layer/light emitting layer/hole preventing layer/electron transporting layer/charge injection layer/cathode
an) anode/charge injection layer/hole transporting layer/light emitting layer/hole preventing layer/electron transporting layer/charge injection layer/cathode

In producing a polymer LED, when a film is formed from a solution by using such polymeric fluorescent substance soluble in an organic solvent, only required is removal of the solvent by drying after coating of this solution, and even in the case of mixing of a charge transporting material and a light emitting material, the same method can be applied, causing an extreme advantage in production. As the film forming method from a solution, there can be used coating methods such as a spin coating method, casting method, micro gravure coating method, gravure coating method, bar coating method, roll coating method, wire bar coating method, dip coating method, spray coating method, screen printing method, flexo printing method, offset printing method, inkjet printing method and the like.

Regarding the thickness of the light emitting layer, the optimum value differs depending on material used, and may properly be selected so that the driving voltage and the light emitting efficiency become optimum values, and for example, it is from 1 nm to 1 μm, preferably from 2 nm to 500 nm, further preferably from 5 nm to 200 nm.

In the polymer LED of the present invention, light emitting materials other than the above-described polymeric fluorescent substance can also be mixed in a light emitting layer. Further, in the polymer LED of the present invention, the light emitting layer containing light emitting materials other than the above-described polymeric fluorescent substance may also be laminated with a light emitting layer containing the above-described polymeric fluorescent substance.

As the light emitting material, known materials can be used. In a compound having lower molecular weight, there can be used, for example, naphthalene derivatives, anthracene or derivatives thereof, perylene or derivatives thereof; dyes such as polymethine dyes, xanthene dyes, coumarine dyes, cyanine dyes; metal complexes of 8-hydroxyquinoline or derivatives thereof, aromatic amine, tetraphenylcyclopentane or derivatives thereof, or tetraphenylbutadiene or derivatives thereof, and the like.

Specifically, there can be used known compounds such as those described in JP-A Nos. 57-51781, 59-195393 and the like, for example.

When the polymer LED of the present invention has a hole transporting layer, as the hole transporting materials used, there are exemplified polyvinylcarbazole or derivatives thereof, polysilane or derivatives thereof, polysiloxane derivatives having an aromatic amine in the side chain or the main chain, pyrazoline derivatives, arylamine derivatives, stilbene derivatives, triphenyldiamine derivatives, polyaniline or derivatives thereof, polythiophene or derivatives thereof, polypyrrole or derivatives thereof, poly(p-phenylenevinylene) or derivatives thereof, poly(2,5-thienylenevinylene) or derivatives thereof, or the like.

Specific examples of the hole transporting material include those described in JP-A Nos. 63-70257, 63-175860, 2-135359, 2-135361, 2-209988, 3-37992 and 3-152184.

Among them, as the hole transporting materials used in the hole transporting layer, preferable are polymer hole transporting materials such as polyvinylcarbazole or derivatives thereof, polysilane or derivatives thereof, polysiloxane derivatives having an aromatic amine compound group in the side chain or the main chain, polyaniline or derivatives thereof, polythiophene or derivatives thereof, poly(p-phenylenevinylene) or derivatives thereof, poly(2,5-thienylenevinylene) or derivatives thereof, or the like, and further preferable are polyvinylcarbazole or derivatives thereof, polysilane or derivatives thereof and polysiloxane derivatives having an aromatic amine compound group in the side chain or the main chain. In the case of a hole transporting material having lower molecular weight, it is preferably dispersed in a polymer binder for use.

Polyvinylcarbazole or derivatives thereof are obtained, for example, by cation polymerization or radical polymerization from a vinyl monomer.

As the polysilane or derivatives thereof, there are exemplified compounds described in Chem. Rev., 89, 1359 (1989) and GB 2300196 published specification, and the like. For synthesis, methods described in them can be used, and a Kipping method can be suitably used particularly.

As the polysiloxane or derivatives thereof, those having the structure of the above-described hole transporting material having lower molecular weight in the side chain or main chain, since the siloxane skeleton structure has poor hole transporting property. Particularly, there are exemplified those having an aromatic amine having hole transporting property in the side chain or main chain.

The method for forming a hole transporting layer is not restricted, and in the case of a hole transporting layer having lower molecular weight, a method in which the layer is formed from a mixed solution with a polymer binder is exemplified. In the case of a polymer hole transporting material, a method in which the layer is formed from a solution is exemplified.

The solvent used for the film forming from a solution is not particularly restricted providing it can dissolve a hole transporting material. As the solvent, there are exemplified chlorine solvents such as chloroform, methylene chloride, dichloroethane and the like, ether solvents such as tetrahydrofuran and the like, aromatic hydrocarbon solvents such as toluene, xylene and the like, ketone solvents such as acetone, methyl ethyl ketone and the like, and ester solvents such as ethyl acetate, butyl acetate, ethylcellosolve acetate and the like.

As the film forming method from a solution, there can be used coating methods such as a spin coating method, casting method, micro gravure coating method, gravure coating method, bar coating method, roll coating method, wire bar coating method, dip coating method, spray coating method, screen printing method, flexo printing method, offset printing method, inkjet printing method and the like, from a solution.

The polymer binder mixed is preferably that does not disturb charge transport extremely, and that does not have strong absorption of a visible light is suitably used. As such polymer binder, polycarbonate, polyacrylate, poly(methyl acrylate), poly(methyl methacrylate), polystyrene, poly(vinyl chloride), polysiloxane and the like are exemplified.

Regarding the thickness of the hole transporting layer, the optimum value differs depending on material used, and may properly be selected so that the driving voltage and the light emitting efficiency become optimum values, and at least a thickness at which no pin hole is produced is necessary, and too large thickness is not preferable since the driving voltage of the device increases. Therefore, the thickness of the hole transporting layer is, for example, from 1 nm to 1 μm, preferably from 2 nm to 500 nm, further preferably from 5 nm to 200 nm.

When the polymer LED of the present invention has an electron transporting layer, known compounds are used as the electron transporting materials, and there are exemplified oxadiazole derivatives, anthraquinonedimethane or derivatives thereof, benzoquinone or derivatives thereof, naphthoquinone or derivatives thereof, anthraquinone or derivatives thereof, tetracyanoanthraquinodimethane or derivatives thereof, fluorenone derivatives, diphenyldicyanoethylene or derivatives thereof, diphenoquinone derivatives, or metal complexes of 8-hydroxyquinoline or derivatives thereof, polyquinoline and derivatives thereof, polyquinoxaline and derivatives thereof, polyfluorene or derivatives thereof, and the like.

Specifically, there are exemplified those described in JP-A Nos. 63-70257, 63-175860, 2-135359, 2-135361, 2-209988, 3-37992 and 3-152184.

Among them, oxadiazole derivatives, benzoquinone or derivatives thereof, anthraquinone or derivatives thereof, or metal complexes of 8-hydroxyquinoline or derivatives thereof, polyquinoline and derivatives thereof, polyquinoxaline and derivatives thereof, polyfluorene or derivatives thereof are preferable, and 2-(4-biphenyl)-5-(4-t-butylphenyl)-1,3,4-oxadiazole, benzoquinone, anthraquinone, tris(8-quinolinol)aluminum and polyquinoline are further preferable.

The method for forming the electron transporting layer is not particularly restricted, and in the case of an electron transporting material having lower molecular weight, a vapor deposition method from a powder, or a method of film-forming from a solution or melted state is exemplified, and in the case of a polymer electron transporting material, a method of film-forming from a solution or melted state is exemplified, respectively.

The solvent used in the film-forming from a solution is not particularly restricted provided it can dissolve electron transporting materials and/or polymer binders. As the solvent, there are exemplified chlorine solvents such as chloroform, methylene chloride, dichloroethane and the like, ether solvents such as tetrahydrofuran and the like, aromatic hydrocarbon solvents such as toluene, xylene and the like, ketone solvents such as acetone, methyl ethyl ketone and the like, and ester solvents such as ethyl acetate, butyl acetate, ethylcellosolve acetate and the like.

As the film-forming method from a solution or melted state, there can be used coating methods such as a spin coating method, casting method, micro gravure coating method, gravure coating method, bar coating method, roll coating method, wire bar coating method, dip coating method, spray coating method, screen printing method, flexo printing method, offset printing method, inkjet printing method and the like.

The polymer binder to be mixed is preferably that which does not extremely disturb a charge transport property, and that does not have strong absorption of a visible light is suitably used. As such polymer binder, poly(N-vinylcarbazole), polyaniline or derivatives thereof, polythiophene or derivatives thereof, poly(p-phenylene vinylene) or derivatives thereof, poly(2,5-thienylene vinylene) or derivatives thereof, polycarbonate, polyacrylate, poly(methyl acrylate), poly(methyl methacrylate), polystyrene, poly(vinyl chloride), polysiloxane and the like are exemplified.

Regarding the thickness of the electron transporting layer, the optimum value differs depending on material used, and may properly be selected so that the driving voltage and the light emitting efficiency become optimum values, and at least a thickness at which no pin hole is produced is necessary, and too large thickness is not preferable since the driving voltage of the device increases. Therefore, the thickness of the electron transporting layer is, for example, from 1 nm to 1 μm, preferably from 2 nm to 500 nm, further preferably from 5 nm to 200 nm.

The substrate forming the polymer LED of the present invention may preferably be that does not change in forming an electrode and layers of organic materials, and there are exemplified glass, plastics, polymer film, silicon substrates and the like. In the case of a opaque substrate, it is preferable that the opposite electrode is transparent or semitransparent.

At least one of the electrodes consisting of an anode and a cathode, is transparent or semitransparent. It is preferable that the anode is transparent or semitransparent.

As the material of this anode, electron conductive metal oxide films, semitransparent metal thin films and the like are used. Specifically, there are used indium oxide, zinc oxide, tin oxide, and composition thereof, i.e. indium/tin/oxide (ITO), and films (NESA and the like) fabricated by using an electron conductive glass composed of indium/zinc/oxide, and the like, and gold, platinum, silver, copper and the like. Among them, ITO, indium/zinc/oxide, tin oxide are preferable. As the fabricating method, a vacuum vapor deposition method, sputtering method, ion plating method, plating method and the like are used. As the anode, there may also be used organic transparent conducting films such as polyaniline or derivatives thereof, polythiophene or derivatives thereof and the like.

The thickness of the anode can be appropriately selected while considering transmission of a light and electric conductivity, and for example, from 10 nm to 10 μm, preferably from 20 nm to 1 μm, further preferably from 50 nm to 500 nm.

Further, for easy charge injection, there may be provided on the anode a layer comprising a phthalocyanine derivative conducting polymers, carbon and the like, or a layer having an average film thickness of 2 nm or less comprising a metal oxide, metal fluoride, organic insulating material and the like.

As the material of a cathode used in the polymer LED of the present invention, that having lower work function is preferable. For example, there are used metals such as lithium, sodium, potassium, rubidium, cesium, beryllium, magnesium, calcium, strontium, barium, aluminum, scandium, vanadium, zinc, yttrium, indium, cerium, samarium, europium, terbium, ytterbium and the like, or alloys comprising two of more of them, or alloys comprising one or more of them with one or more of gold, silver, platinum, copper, manganese, titanium, cobalt, nickel, tungsten and tin, graphite or graphite intercalation compounds and the like. Examples of alloys include a magnesium-silver alloy, magnesium-indium alloy, magnesium-aluminum alloy, indium-silver alloy, lithium-aluminum alloy, lithium-magnesium alloy, lithium-indium alloy, calcium-aluminum alloy and the like. The cathode may be formed into a laminated structure of two or more layers.

The thickness of the cathode can be appropriately selected while considering transmission of a light and electric conductivity, and for example, from 10 nm to 10 μm, preferably from 20 nm to 1 μm, further preferably from 50 nm to 500 nm.

As the method for fabricating a cathode, there are used a vacuum vapor deposition method, sputtering method, lamination method in which a metal thin film is adhered under heat and pressure, and the like. Further, there may also be provided, between a cathode and an organic layer, a layer comprising an conducting polymer, or a layer having an average film thickness of 2 nm or less comprising a metal oxide, metal fluoride, organic insulation material and the like, and after fabrication of the cathode, a protective layer may also be provided which protects the polymer LED. For stable use of the polymer LED for a long period of time, it is preferable to provide a protective layer and/or protective cover for protection of the device in order to prevent it from outside damage.

As the protective layer, there can be used a polymeric compound, metal oxide, metal fluoride, metal borate and the like. As the protective cover, there can be used a glass plate, a plastic plate the surface of which has been subjected to lower-water-permeation treatment, and the like, and there is suitably used a method in which the cover is pasted with an device substrate by a thermosetting resin or light-curing resin for sealing. If space is maintained using a spacer, it is easy to prevent an device from being injured. If an inner gas such as nitrogen and argon is sealed in this space, it is possible to prevent oxidation of a cathode, and further, by placing a desiccant such as barium oxide and the like in the above-described space, it is easy to suppress the damage of an device by moisture adhered in the production process. Among them, any one means or more are preferably adopted.

The polymer LED of the present invention can be used for a flat light source, a segment display, a dot matrix display, and a liquid crystal display as a back light, etc.

For obtaining light emission in plane form using the polymer LED of the present invention, an anode and a cathode in the plane form may properly be placed so that they are laminated each other. Further, for obtaining light emission in pattern form, there is a method in which a mask with a window in pattern form is placed on the above-described plane light emitting device, a method in which an organic layer in non-light emission part is formed to obtain extremely large thickness providing substantial non-light emission, and a method in which any one of an anode or a cathode, or both of them are formed in the pattern. By forming a pattern by any of these methods and by placing some electrodes so that independent on/off is possible, there is obtained a display device of segment type which can display digits, letters, simple marks and the like. Further, for forming a dot matrix device, it may be advantageous that anodes and cathodes are made in the form of stripes and placed so that they cross at right angles. By a method in which a plurality of kinds of polymeric compounds emitting different colors of lights are placed separately or a method in which a color filter or luminescence converting filter is used, area color displays and multi color displays are obtained. A dot matrix display can be driven by passive driving, or by active driving combined with TFT and the like. These display devices can be used as a display of a computer, television, portable terminal, portable telephone, car navigation, view finder of a video camera, and the like.

Further, the above-described light emitting device in plane form is a thin self-light-emitting one, and can be suitably used as a flat light source for back-light of a liquid crystal display, or as a flat light source for illumination. Further, if a flexible plate is used, it can also be used as a curved light source or a display.

Hereafter, in order to explain the present invention in detail with showing examples, but the present invention is not limited to these.

Here, about the number average molecular weight, the polystyrene reduced number average molecular weight was obtained by gel permeation chromatography (GPC: HLC-8220GPC produced by TOSOH, or SCL-10A produced by Shimadzu) using chloroform as a solvent.

### EXAMPLE 1

### Synthesis of Polymer Compound 1

0.62 g (1.3 mmol) of Compound A and 0.50 g (3.2 mmol) of 2,2′-bipyridyl were charged into a reaction vessel, and inside of the reaction system was replaced with nitrogen gas. Into this, 40 ml of tetrahydrofuran (dehydrated solvent) deaerated by argon gas bubbling was added. Next, 11.0 g (3.6 mmol) of bis(1,5-cyclooctadiene)nickel(0) was added to this mixed solution, and reacted at 60° C. for 3 hours. Here, the reaction was conducted in nitrogen-gas atmosphere. After the reaction, this solution was cooled, then it poured into a mixed solution of 25% aqueous ammonia 10 ml/methanol 120 ml/ion-exchanged water 50 ml, and stirred for about one hour. Next, resulting precipitation was collected by filtration. After methanol washing, the precipitation was dried under reduced-pressure for 2 hours. Next, the precipitation was dissolved in toluene 30 mL, 1N hydrogen chloride 30 mL was added to this, and stirred for 1 hour. After removing the aqueous layer, 4% ammonia water 30 mL was added to the organic layer, and after stirring for 1 hour, the aqueous layer was removed. The organic layer was added dropwise to methanol 150 mL, and stirred for 1 hour. The deposited precipitation was filtrated and dried under reduced pressure for 2 hours. The obtained amount of the resultant Polymer Compound 1 was 0.14 g.

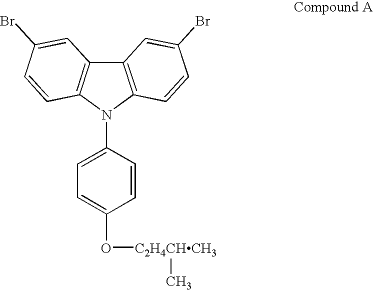

The average molecular weights of Polymer Compound 1 were Mn=3.3×10³ and Mw=7.4×10³.

### PREPARATION EXAMPLE 1

### Manufacture of Complex Composition 1

Polymer Compound 1 and a triplet light-emitting complex (iridium complex Ir(ppy)₃), respectively 2.7 mg and 0.15 mg, were mixed and dissolved in 0.2 ml of 1,2-dichloroethane to prepare Solution 1.

### PREPARATION EXAMPLE 2

### Manufacture of Complex Composition 2

Polymer Compound 1, an electron transporting compound (PBD), and a triplet light-emitting complex (iridium complex Ir(ppy)₃), respectively 1.8 mg, 0.9 mg and 0.15 mg, were mixed and dissolved in 0.2 ml of 1,2-dichloroethane, to prepare Solution 2.

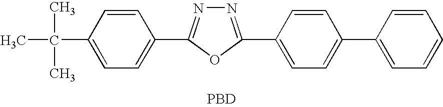

### PREPARATION EXAMPLE 3

### Manufacture of Complex Composition 3

Polymer Compound 1, and a triplet light-emitting complex (iridium complex Btp₂Ir(acac)), respectively 2.7 mg and 0.15 mg, were mixed and dissolved in 0.2 ml of 1,2-dichloroethane to prepare Solution 3.

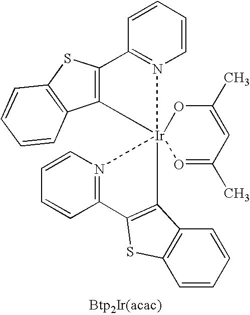

### PREPARATION EXAMPLE 4

### Manufacture of Complex Composition 4

Polymer Compound 1, and a triplet light-emitting complex (iridium complex FIr(pic)), respectively 2.7 mg and 0.15 mg, were mixed and dissolved in 0.2 ml of 1,2-dichloroethane to prepare Solution 4.

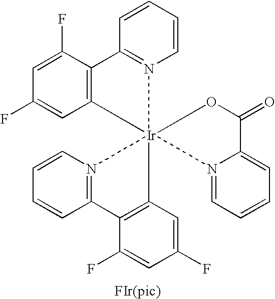

### EXAMPLE 2

### Preparation of Thin Film and PL Spectrum of the Thin Film

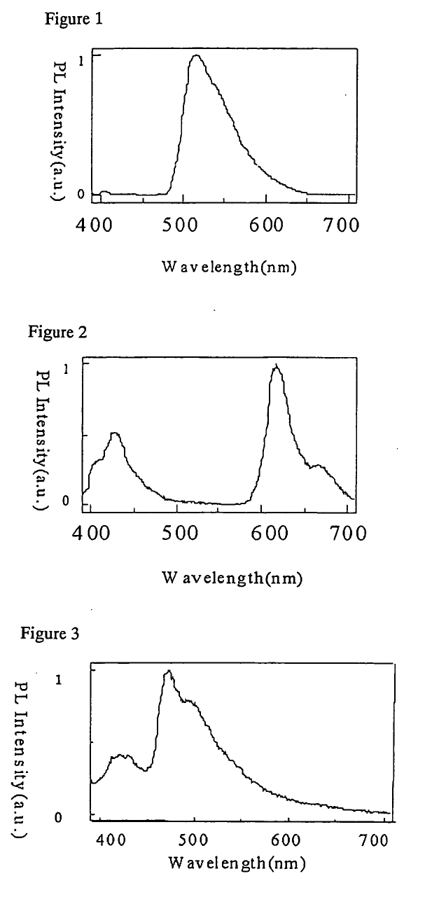

Complex compositions 1, 3, and 4 were spin-coated on glass plates for about 40 seconds at 1000 rpm. The remaining solvent in the film was removed by drying under reduced pressure overnight. PL spectrum of the thin film was measured by JASCO FP-6500 spectrofluorometer. The spectrum are shown in FIGS. 1 to 3.

### EXAMPLE 3

### Preparation of a Device, and Evaluation of the Device Characteristic

ITO substrate (commercial product. sheet resistance about 40Ω) was cleaned by ultrasonic washing using a surfactant, purewater, acetone, 1,2-dichloroethane, andisopropanol, and then treated by oxygen plasma processing.

On the resultant ITO, Baytron P (product of BAYER) was spin-coated for 40 seconds at 1500 rpm, and heated at 200° C. on a hot plate to obtain a buffer layer having a film thickness of about 40 nm.

Then, by carrying out spin-coating of Solution 1 for 40 seconds at 3000 rpm, a light emitting layer having a film thickness of 70 nm was laminated.

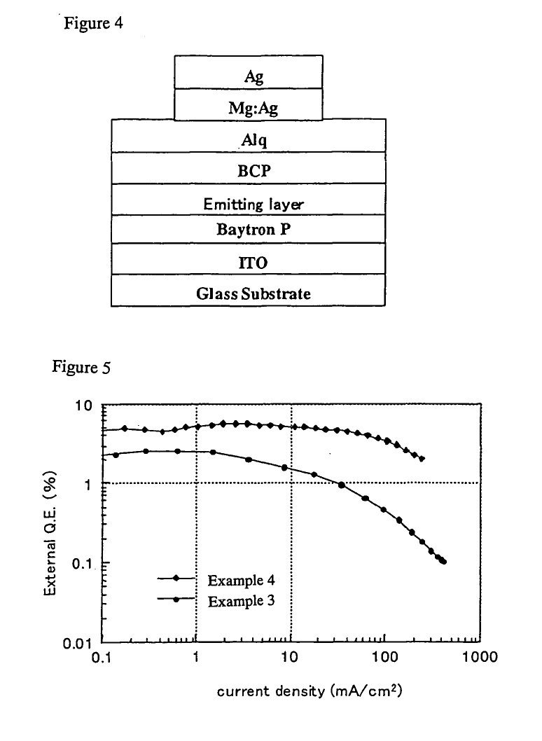

The resultant laminate film was dried under reduced pressure overnight to remove the residual solvent in the film. Furthermore, by using a vacuum-deposition apparatus, vapor deposition of BCP was carried out at a vapor deposition speed of 0.4 nm/sec at a vacuum degree of 10⁻³ Pa or less to laminate a hole preventing layer having a film thickness of 20 nm, and vapor deposition of Alq₃ was carried out at a vapor deposition speed of 0.4 nm/sec to laminate an electron transporting layer having a film thickness of 20 nm. Finally, a metal mask pattern was put on the resultant organic multilayer film, codeposition of silver and magnesium at a rate of 10:1 was carried out by vapor deposition at a deposition speed of 0.55 nm/sec, and at a film thickness of 100 nm, and further by carrying out vapor deposition of silver in a film thickness of 50 nm at a vapor deposition speed of 0.2 nm/sec to form a cathode of area 0.025 cm², the device structure shown in FIG. 4 was produced.

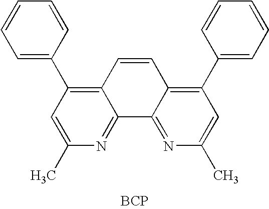

By applying voltage to the resultant device, green light-emission having a peak at 510 nm was observed from the whole electrode plane. The maximum external quantum yield of the device showed 2.5% (FIG. 5), and showed 85 cd/m² at 11.8V and 1 mA/cm², and 515 cd/m² at 13.1V, 10 mA/cm², and 1570 cd/m² at 15V, 100 mA/cm².

### EXAMPLE 4

### Preparation of a Device, and Evaluation of the Device Characteristic

A device was prepared as the same manner with the above except using Solution 2. The maximum external quantum yield of the device showed 5.5% (FIG. 5), and showed 175 cd/m² at 14.5V and 1 mA/cm², and 1730 cd/m² at 18.3V, 10 mA/cm², and 11500 cd/m² at 22.9 V, 100 mA/cm².

### EXAMPLE 5

### Preparation of a Device, and Evaluation of the Device Characteristic

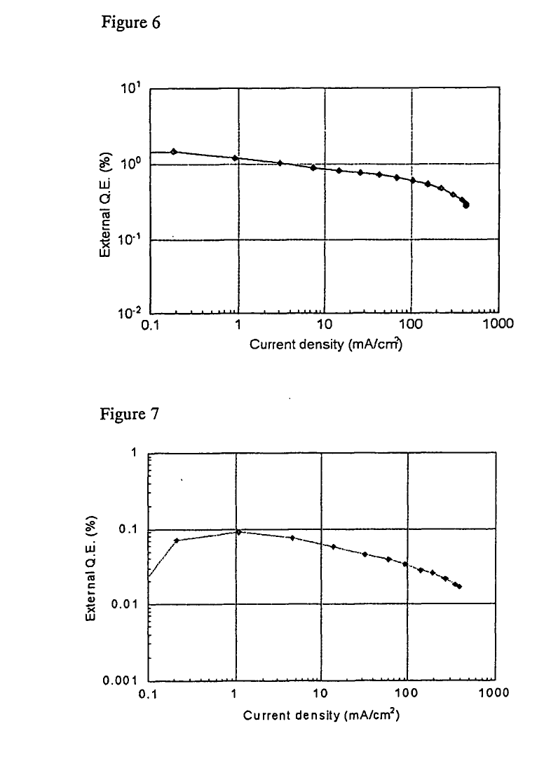

A device was prepared as the same manner with the above except using Solution 3. The maximum external quantum yield of the device showed 1.4% (FIG. 6), and showed 9.8 cd/m² at 9V and 1 mA/cm², and 72 cd/m² at 10.5 V, 10 mA/cm², and 510 cd/m² at 12V, 100 mA/cm².

### EXAMPLE 6

### Preparation of a Device, and Evaluation of the Device Characteristic

A device was prepared as the same manner with the above except using Solution 4. The maximum external quantum yield of the device showed 0.09% (FIG. 7), and showed 2.2 cd/m² at 11V and 1 mA/cm², and 16 cd/m² at 12V, 10 mA/cm², and 81 cd/m² at 13.5V, 100 mA/cm².

The complex composition and the polymer complex compound of the present invention are a triplet light-emitting materials having carbazolediyl group as a repeating unit, and when a light emitting layer of a light-emitting device is formed using this light-emitting material, the device can show the expected performance stably. Therefore, the complex composition and a polymer complex compound of the present invention can be used suitably as a light-emitting material of polymer LED.

1. A complex composition containing a polymer compound and a metal complex showing light-emission from triplet excited state comprising the repeating unit represented by formula (1), 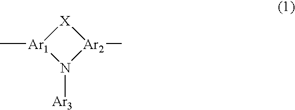
(wherein, Ar₁ and Ar₂ each independently represent a trivalent aromatic hydrocarbon group or a trivalent heterocyclic group, Ar₃ represents an aromatic hydrocarbon group or a heterocyclic group, and said Ar₃ has on the ring a group selected from alkyl group, alkoxy group, alkylthio group, alkylsilyl group, alkylamino group, aryl group, aryloxy group, arylalkyl group, arylalkoxy group, arylalkenyl group, arylalkynyl group, arylamino group, monovalent heterocyclic group, and cyano group. X represents a single bond or a connecting group).

2. A complex composition according to claim 1, wherein the connecting group is a group represented by the below formulas 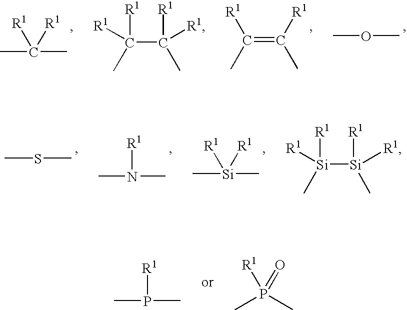
(wherein, R₁ each independently represents a hydrogen atom, halogen atom, alkyl group, alkoxy group, alkylthio group, alkylamino group, aryl group, aryloxy group, arylthio group, arylamino group, arylalkyl group, arylalkoxy group, arylalkylthio group, arylalkylamino group, acyloxy group, amide group, arylalkenyl group, arylalkynyl group, monovalent heterocyclic group, or cyano group).

3. A complex composition according to claim 1, wherein X is a single bond.

4. A complex composition according to claim 1, wherein the trivalent aromatic hydrocarbon group is a group represented by the below formula, 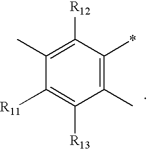
(wherein, R₁₁, R₁₂, and R₁₃ each independently represent a hydrogen atom, halogen atom, alkyl group, alkoxy group, alkylthio group, alkylamino group, aryl group, aryloxy group, arylthio group, arylamino group, arylalkyl group, arylalkoxy group, arylalkylthio group, arylalkylamino group, acyl group, acyloxy group, amide group, imino group, substituted silyl group, substituted silyloxy group, substituted silylthio group, substituted silylamino group, monovalent heterocyclic group, arylalkenyl group, arylethynyl group, or cyano group. * means a bonding to X, and means a bonding to N.).

5. A complex composition according to claim 1, wherein the aromatic hydrocarbon group is a group represented by the below formula, 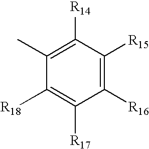
(wherein, R₁₄, R₁₅, R₁₆, R₁₇, and R₁₈ each independently represent a hydrogen atom, alkyl group, alkoxy group, alkylthio group, alkylsilyl group, alkylamino group, aryl group, aryloxy group, arylalkyl group, arylalkoxy group, arylalkenyl group, arylalkynyl group, arylamino group, monovalent heterocyclic group, or cyano group, but at least one of R₁₄, R₁₅, R₁₆ and R₁₇ is not a hydrogen atom.).

6. A complex composition according to claim 1, wherein the composition further include an electron transporting compound.

7. A polymer complex compound which contains a repeating unit represented by the above formula (1), and a metal complex structure showing light-emission from triplet excited state, and exhibits a visible light-emission in the solid state.

8. A polymer complex compound according to claim 7, wherein the connecting group is a group represented by the below formulas, 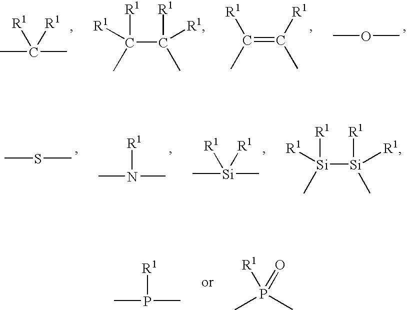
(wherein, R₁ each independently represent a hydrogen atom, halogen atom, alkyl group, alkoxy group, alkylthio group, alkylamino group, aryl group, aryloxy group, arylthio group, arylamino group, arylalkyl group, arylalkoxy group, arylalkylthio group, arylalkylamino group, acyloxy group, amide group, arylalkenyl group, arylalkynyl group, monovalent heterocyclic group, or cyano group.).

9. A polymer complex compound according to claim 7, wherein X is a single bond.

10. A polymer complex compound according to claim 7, wherein the trivalent aromatic hydrocarbon group is a group represented by the below formulas 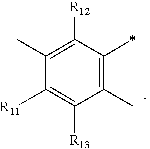
(wherein, R₁₁, R₁₂, and R₁₃ each independently represent a hydrogen atom, halogen atom, alkyl group, alkoxy group, alkylthio group, alkylamino group, aryl group, aryloxy group, arylthio group, arylamino group, arylalkyl group, arylalkoxy group, arylalkylthio group, arylalkylamino group, acyl group, acyloxy group, amide group, imino group, substituted silyl group, substituted silyloxy group, substituted silylthio group, substituted silylamino group, monovalent heterocyclic group, arylalkenyl group, arylethynyl group, or cyano group. * means a bonding to X, and means a bonding to N.).

11. A polymer complex compound according to claim 7, wherein the aromatic hydrocarbon group is a group represented by the below formulas, 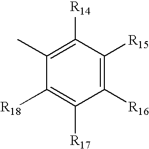
(wherein, R₁₄, R₁₅, R₁₆, R₁₇, and R₁₈, each independently represent a hydrogen atom, alkyl group, alkoxy group, alkylthio group, alkylsilyl group, alkylamino group, aryl group, aryloxy group, arylalkyl group, arylalkoxy group, arylalkenyl group, arylalkynyl group, arylamino group, monovalent heterocyclic group, or cyano group, but at least one of R₁₄, R₁₅, R₁₆ and R₁₇ is not a hydrogen atom.).

12. A polymer light-emitting device containing a layer which contains a complex composition containing a polymer compound and a metal complex showing light-emission from triplet excited state comprising the repeating unit represented by formula (1), 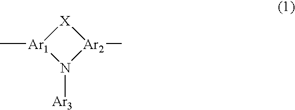
(wherein, Ar₁ and Ar₂ each independently represent a trivalent aromatic hydrocarbon group or a trivalent heterocyclic group, Ar₃ represents an aromatic hydrocarbon group or a heterocyclic group, and said Ar₃ has on the ring a group selected from alkyl group, alkoxy group, alkylthio group, alkylsilyl group, alkylamino group, aryl group, aryloxy group, arylalkyl group, arylalkoxy group, arylalkenyl group, arylalkynyl group, arylamino group, monovalent heterocyclic group, and cyano group. X represents a single bond or a connecting group), or a polymer complex compound which contains a repeating unit represented by the above formula (1), and a metal complex structure showing light-emission from triplet excited state, and exhibits a visible light-emission in the solid state, between the electrodes consisting of an anode and a cathode.
